(19) United States
(12) Patent Application Publication
(10) Pub. No.: US 2014/0080051 A1
(43) Pub. Date: Mar. 20, 2014

(54) TONER AND METHOD FOR PRODUCING TONER

(71) Applicants: Toyoshi SAWADA, Kanagawa (JP); Masahide YAMADA, Shizuoka (JP); Atsushi YAMAMOTO, Osaka (JP); Tatsuya MORITA, Kanagawa (JP); Satoyuki SEKIGUCHI, Shizuoka (JP); Keiji MAKABE, Shizuoka (JP); Kousuke NAGATA, Shizuoka (JP)

(72) Inventors: Toyoshi SAWADA, Kanagawa (JP); Masahide YAMADA, Shizuoka (JP); Atsushi YAMAMOTO, Osaka (JP); Tatsuya MORITA, Kanagawa (JP); Satoyuki SEKIGUCHI, Shizuoka (JP); Keiji MAKABE, Shizuoka (JP); Kousuke NAGATA, Shizuoka (JP)

(21) Appl. No.: 14/028,665

(22) Filed: Sep. 17, 2013

(30) Foreign Application Priority Data
Sep. 18, 2012 (JP) 2012-204322

(51) Int. Cl. G03G 9/087; G03G 9/08

(52) U.S. Cl. CPC G03G 9/08764; G03G 9/0804
USPC 430/109.5; 430/137.13

(57) ABSTRACT

To provide a toner (X), which contains toner particles, each toner particle contains: a core phase (Q) containing a crystalline resin (A); and a shell phase (S) provided on a surface of the core phase (Q), where the shell phase (S) contains a crystalline polyurethane resin (B), wherein maximum peak temperature (Ta) of heat of melting of the crystalline resin (A) is 40° C. to 70° C., and maximum peak temperature (Tu) of heat of melting of the crystalline polyurethane resin (B) is 50° C. to 90° C.

### BACKGROUND OF THE INVENTION

1. Field of the Invention

The present invention relates to a toner, and a method producing a toner.

2. Description of the Related Art

As a toner having a small melting energy and excellent heat resistant storage stability, known is a core-shell toner composed of a shell phase and a core phase (see Japanese Patent Application Laid-Open (JP-A) No. 61-118758).

Since the toner cannot be melted until the entire toner particles are heated at high temperature for a long period. There has been a problem that such core-shell toner does not have sufficient heat adhesion.

In order to improve heat adhesion of a toner, proposed are core-shell toner particles each composed of a shell phase and a core phase, in which a sharp melt characteristic is provided to the shell phase (see JP-A No. 2010-47752).

### SUMMARY OF THE INVENTION

However, even the aforementioned toner particles do not have sufficient heat adhesion. There has therefore a need for developing a core-shell toner having excellent heat adhesion.

Accordingly, the present invention aims to solve the aforementioned various problems in the art, and to achieve the following object. The object is to provide a toner, which excels low temperature fixing ability and heat resistant storage stability, as well as heat adhesion, has high adhesion strength, and is capable of forming an image of excellent glossiness and water resistance.

The means for solving the aforementioned problem is as follows:

The toner of the present invention contains:

toner particles, each toner particle containing:

a core phase (Q) containing a crystalline resin (A); and

a shell phase (S) provided on a surface of the core phase (Q), where the shell phase (S) contains a crystalline polyurethane resin (B),

wherein maximum peak temperature (Ta) of heat of melting of the crystalline resin (A) is 40° C. to 70° C., and maximum peak temperature (Tu) of heat of melting of the crystalline polyurethane resin (B) is 50° C. to 90° C.

The present invention can solve the various problems in the art and achieve the aforementioned object, and can provide a toner, which excels low temperature fixing ability and heat resistant storage stability, as well as heat adhesion, has high adhesion strength, and is capable of forming an image of excellent glossiness and water resistance.

### BRIEF DESCRIPTION OF THE DRAWINGS

FIG. 1 is a schematic diagram of a structural example of an experimental device for use in the production of the toner (X) of the present invention.

### DETAILED DESCRIPTION OF THE INVENTION

The structure of the present invention is specifically explained hereinafter based on the embodiment thereof.

### (Toner (X))

The toner (X) of the present invention contains toner particles, each containing a core phase (Q), and a shell phase (S) on a surface of the core phase (Q).

### <Core Phase (Q)>

The core phase (Q) contains at least a crystalline resin (A), and may further contain additives (e.g., a colorant, a charge controlling agent, an antioxidant, an anti-blocking agent, a heat resistance stabilizing agent, and a flow improving agent), if necessary.

### <<Crystalline Resin (A)>>

The crystalline resin (A) for use in the present invention is a resin having a ratio (Tm/Ta) of 0.8 to 1.55, where the ratio is a ratio of a softening point of the resin (abbreviated as Tm hereinafter) to maximum peak temperature of heat of melting (abbreviated as Ta hereinafter), and having a clear endothermic peak in DSC. Tm and Ta can be measured by the following method.

### [Measuring Method of Tm]

Measurement of Tm is performed with a flow tester at a load of 1.96 MPa. For example, by means of an elevated flow tester (e.g., CFT-500D, manufactured by Shimadzu Corporation), 1 g of a measurement sample is heated at the heating rate of 6° C./min, and at the same time, load of 1.96 MPa is applied by a plunger to extrude the sample from a nozzle having a diameter of 1 mm and length of 1 mm, during which “an amount of the plunger of the flow tester pushed down (flow rate)” relative to “temperature” is plotted in a graph. The temperature relative to ½ the maximum value of the amount of the plunger pushed down is read from the graph, and this temperature (temperature at which a half of the measurement sample is flown out) is determined as Tm.

### [Measuring Method of Maximum Peak Temperature of Heat of Melting]

The measurement is performed by means of a differential scanning calorimeter (e.g., DSC210, manufactured by Seiko Instruments Inc.). In the measurement, a sample is prepared by melting the resin (A) at 130° C., cooling it from this temperature to 70° C. at the rate of 1.0° C./min, and cooling it from 70° C. to 10° C. at the rate of 0.5° C./min, and the sample is cooled to 0° C. at the rate of 10° C./min and measured for endothermic and exothermic changes at the heating rate of 20° C./min, to thereby determining the temperature corresponding to the maximum peak of the endothermic value.

Specifically, as a pretreatment, (A) provided for the measurement of Ta is melted at 130° C., followed by cooling (A) from 130° C. to 70° C. at the rate of 1.0° C./min. Subsequently, (A) is cooled from 70° C. to 10° C. at the rate of 0.5° C./min. Then, (A) is heated at the heating rate of 20° C./min to measure endothermic and exothermic changes by DSC, to thereby plot “endothermic or exothermic value” verses “temperature” in a graph. The endothermic peak temperature appeared between 20° C. to 100° C. in the graph is determined as Ta′. In the case where there are a few endothermic peaks within the aforementioned temperature range, the temperature of the peak at which the absorption heat capacity is the largest is determined as Ta′. Finally, the sample is stored for 6 hours at (Ta′−10)° C., followed by storing the sample for 6 hours at (Ta′−15)° C.

Next, after cooling (A) stored in the above-described manner to 0° C. at the cooling rate of 10° C./min by means of DSC, the sample (A) is heated at the heating rate of 20° C./min to measure the endothermic and exothermic changes, to thereby draw a graph of “endothermic value” and “temperature”. The temperature corresponding to the maximum peak of the endothermic value in the graph is determined as the maximum peak temperature of heat of melting (Ta). The below-described Tu is measured in the same manner as described above.

The Ta of the crystalline resin (A) is 40° C. to 70° C., preferably 45° C. to 68° C., and more preferably 50° C. to 65° C. When the Ta of (A) is lower than 40° C., heat resistant storage stability of a toner (X) is impaired, and hence not preferable. When the Ta of (A) is higher than 70° C., a minimum fixing temperature of a toner (X) elevates, and hence not preferable.

Examples of the crystalline resin (A) for use in the present invention include a crystalline polyester resin (A1), a crystalline polyurethane resin (A2), and a crystalline vinyl resin (A3). As for (A), any of (A1) to (A3) may be used alone, or in combination.

Examples of the crystalline polyester resin (A1) include a crystalline polyester resin containing diol (1), and dicarboxylic acid (2) as constitutional units thereof.

Examples of the diol (1) include: C2-C30 alkylene glycol (e.g., ethylene glycol, 1,2-propylene glycol, 1,3-propylene glycol, 1,4-butanediol, 1,6-hexanediol, octanediol, decanediol, dodecanediol, tetradecanediol, neopentyl glycol, and 2,2-diethyl-1,3-propane diol); alkylene ether glycol having the number average molecular weight (abbreviated as Mn, hereinafter) of 106 to 10,000 (e.g., diethylene glycol, triethylene glycol, dipropylene glycol, polyethylene glycol, polypropylene glycol, and polytetramethylene ether glycol); C6-C24 alicyclic diol (e.g., 1,4-cyclohexane dimethanol, and hydrogenated bisphenol A); an alkylene oxide (abbreviated as AO, hereinafter) adduct (the number of moles added: 2 to 100) of the alicyclic diol having Mn of 100 to 10,000 [e.g., ethylene oxide (abbreviated as EO hereinafter) 10 mol adduct of 1,4-cyclohexane dimethanol]; AO [e.g., EO, propylene oxide (abbreviated as PO, hereinafter), and butylene oxide (abbreviated as BO, hereinafter)] adduct (the number of moles added: 2 to 100) of C15-C30 bisphenol (e.g., bisphenol A, bisphenol F, and bisphenol S) or C12-C24 polyphenol (e.g., catechol, hydroquinone, and resorcin) (e.g., bisphenol A EO (2 to 4 mol) adduct, and bisphenol A PO (2 to 4 mol) adduct); polylactone diol having a weight average molecular weight (abbreviated as Mw, hereinafter) of 100 to 5,000 (e.g., poly-ε-caprolactonediol); and polybutadiene diol having Mw of 1,000 to 20,000.

Among them, alkylene glycol and AO adduct of bisphenol are preferable, AO adduct of bisphenol is more preferable, and AO adduct of bisphenol, and a mixture of AO adduct of bisphenol and alkylene glycol are even more preferable.

Examples of dicarboxylic acid (2) include: C4-C32 alkane dicarboxylic acid (e.g., succinic acid, adipic acid, sebacic acid, azelaic acid, dodecane dicarboxylic acid, and octadecane dicarboxylic acid); C4-C32 alkene dicarboxylic acid (e.g., maleic acid, fumaric acid, citraconic acid, and measaconic acid); C8-C40 branched alkene dicarboxylic acid [e.g., dimer acid, and alkenyl succinic acid (e.g., dodecenyl succinic acid, pentadecenyl succinic acid, octadecenyl succinic acid)]; C12-C40 branched alkane dicarboxylic acid [e.g., alkyl succinic acid (e.g., decyl succinic acid, dodecyl succinic acid, and octadecyl succinic acid)]; and C8-C20 aromatic dicarboxylic acid (e.g., phthalic acid, isophthalic acid, terephthalic acid, and naphthalene dicarboxylic acid).

Among them, alkene dicarboxylic acid and aromatic dicarboxylic acid are preferable, and aromatic dicarboxylic acid is more preferable.

In view of heat resistant storage stability of a toner (X), (A1) contains diol (1) and dicarboxylic acid (2), a total number of carbon atoms of which is preferably 10 or greater, more preferably 12 or greater, and even more preferably 14 or greater. In view of low temperature fixing ability when a toner (X) is used as base particles of an electrophotographic toner, the total number of carbon atoms is preferably 52 or smaller, more preferably 45 or smaller, even more preferably 40 or smaller, and particularly preferably 30 or smaller. Moreover, dicarboxylic acid (2) may optionally contain C6-C30 aromatic dicarboxylic acid.

Examples of the crystalline polyurethane resin (A2) include a crystalline polyurethane resin (A2-1) having the diol (1) and/or the diamine (3), and the diisocyanate (4) as constitutional units thereof, and a crystalline polyurethane resin (A2-2) having the crystalline polyester resin (A1), the diol (1) and/or diamine (3), and diisocyanate (4) as constitutional units thereof.

Examples of the diamine (3) include C2-C18 aliphatic diamine, and C6-C20 aromatic diamine. Examples of C2-C18 aliphatic diamine include linear-chain aliphatic diamine, and cyclic aliphatic diamine.

Examples of the linear-chain aliphatic diamine include C2-C12 alkylene diamine (e.g., ethylene diamine, trimethylene diamine, tetramethylene diamine, and hexamethylene diamine).

Examples of the cyclic aliphatic diamine include C4-C15 alicyclic diamine {e.g., 1,3-diaminocyclohexane, isophorone diamine, menthene diamine, 4,4′-methylene dicyclohexanediamine (e.g., hydrogenated methylene dianiline), and 3,9-bis (3-aminopropyl)-2,4,8,10-tetraoxaspiro[5,5]undecane}.

Examples of the C6-C20 aromatic diamine include 1,2-, 1,3- or 1,4-phenylene diamine, 2,4′- or 4,4′-diphenylmethane diamine, diaminodiphenyl sulfone, benzidine, thiodianiline, bis(3,4-diaminophenyl)sulfone, 2,6-diaminopyridine, m-aminobenzyl amine, naphthylene diamine, 2,4- or 2,6-tolylene diamine, crude tolylene diamine, diethyltolylene diamine, 4,4′-diamino-3,3′-dimethyldiphenylmethane, 4,4′-bis(o-toluidine), dianisidine, diaminoditolylsulfone, 1,3-dimethyl-2,4-diaminobenzene, 1,3-diethyl-2,4-diaminobenzene, 1,3-dimethyl-2,6-diaminobenzene, 1,4-diethyl-2,5-diaminobenzene, 1,4-diisopropyl-2,5-diaminobenzene, 1,4-dibutyl-2,5-diaminobenzene, 2,4-diaminomesitylene, 1,3,5-triethyl-2,4-diaminobenzene, 1,3,5-triisopropyl-2,4-diaminobenzene, 1-methyl-3,5-diethyl-2,4-diaminobenzene, 1-methyl-3,5-diethyl-2,6-diaminobenzene, 2,3-dimethyl-1,4-diaminonaphthalene, 2,6-dimethyl-1,5-diaminonaphthalene, 2,6-diisopropyl-1,5-diaminonaphthalene, 2,6-dibutyl-1,5-diaminonaphthalene, 3,3′,5,5′-tetramethylbenzidine, 3,3′,5,5′-tetraisopropylbenzidine, 3,3′,5,5′-tetramethyl-4,4′-diaminodiphenylmethane, 3,3′,5,5′-tetraethyl-4,4′-diaminodiphenylmethane, 3,3′,5,5′-tetraisopropyl-4,4′-diaminodiphenylmethane, 3,3′,5,5′-tetrabutyl-4,4′-diaminodiphenylmethane, 3,5-diethyl-3′-methyl-2′,4-diaminodiphenylmethane, 3,5-diisopropyl-3′-methyl-2′,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraisopropyl-4,4′-diaminobenzophenone, 3,3′,5,5′-tetraethyl-4,4′-diaminodiphenyl ether, 3,3′,5,5′-tetraisopropyl-4,4′-diaminodiphenylsulfone, and a mixture thereof.

Examples of the diisocyanate (4) include C6-C20 (excluding carbon atoms in NCO groups, which is the same hereinafter) aromatic diisocyanate, C2-C18 aliphatic diisocyanate, modified products (e.g., modified products containing a urethane group, carboxylmide group, allophanate group, urea group, biuret group, uretdione group, uretimine group, isocyanurate group, or oxazolidone group) of the preceding diisocyanates, and a mixture of two or more of the preceding diisocyanates.

Examples of the aromatic diisocyanate include 1,3- or 1,4-phenylene diisocyanate, 2,4- or 2,6-tolylene diisocyanate (TDI), crude TDI, m- or p-xylene diisocyanate (XDI), α,α,α′,α′-tetramethylxylene diisocyanate (TMXDI), 2,4′- or 4,4′-diphenylmethanediisocyanate (MDI), crude MDI {e.g., crude diaminophenyl methane [e.g., a condensation product between formaldehyde and aromatic amine (aniline) or a mixture thereof]}, and a mixture thereof.

Examples of the aliphatic diisocyanate include linear-chain aliphatic diisocyanate, and cyclic aliphatic diisocyanate.

Examples of the linear-chain aliphatic diisocyanate include ethylene diisocyanate, tetramethylene diisocyanate, hexamethylene diisocyanate (HDI), dodecamethylene diisocyanate, 2,2,4-trimethylhexamethylene diisocyanate, lysine diisocyanate, 2,6-diisocyanatomethylcaproate, bis(2-isocyanateethyl)fumarate, bis(2-isocyanatoethyl)carbonate, and a mixture thereof.

Examples of the cyclic aliphatic diisocyanate include isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- or 2,6-norbornanediisocyanate, and a mixture thereof.

As for the modified product of diisocyanate, a modified product containing a urethane group, carboxylmide group, allophanate group, urea group, biuret group, uretdione group, uretimine group, isocyanurate group, or oxazolidone group is used, and examples thereof include modified MDI (e.g., urethane-modified MDI, carbodiimide-modified MDI, and trihydrocarbylphosphate-modified MDI), urethane-modified TDI, and a mixture thereof [e.g., a mixture of modified MDI and urethane-modified TDI (isocyanate-containing prepolymer)].

Among these diisocyanates (4), C6-C15 aromatic diisocyanate and C4-C15 aliphatic diisocyanate are preferable, and TDI, MDI, HDI, hydrogenated MDI, and IPDI are more preferable.

The crystalline polyurethane resin (A2) may contain, in addition to the diol (1), diol (1′) containing at least one selected from the group consisting of a carboxylic acid (salt) group, a sulfonic acid (salt) group, a sulfamic acid (salt) group, and a phosphoric acid (salt) group, as constitutional units thereof. (A2) containing diol (1′) as a constitutional unit thereof can contribute to improvement charging ability, and heat resistant storage stability of a (X).

Note that, in the present specification, “acid (salt)” means acid or acid salt.

Examples of the diol (1′) containing a carboxylic acid (salt) group include tartaric acid (salt), 2,2-bis(hydroxymethyl)propanoic acid (salt), 2,2-bis(hydroxymethyl)butanoic acid (salt), and 3-[bis(2-hydroxyethyl)amino]propanoic acid (salt).

Examples of the diol (1′) containing a sulfonic acid (salt) group include 2,2-bis(hydroxymethyl)ethane sulfonic acid (salt), 2-[bis(2-hydroxyethyl)amino]ethane sulfonic acid (salt), and 5-sulfo-isophthalic acid-1,3-bis(2-hydroxyethyl)ester.

Examples of the diol (1′) containing a sulfamic acid (salt) group include N,N-bis(2-hydroxyethyl)sulfamic acid (salt), N,N-bis(3-hydroxypropyl)sulfamic acid (salt), N,N-bis(4-hydroxybutyl)sulfamic acid (salt), and N,N-bis(2-hydroxypropyl)sulfamic acid (salt).

Examples of the diol (1′) containing a phosphoric acid (salt) group include bis(2-hydroxyethyl)phosphate.

Examples of the salt constituting acid salt include ammonium salt, amine salt (e.g., methylamine salt, dimethylamine salt, trimethylamine salt, ethylamine salt, diethylamine salt, triethylamine salt, propylamine salt, dipropylamine salt, tripropylamine salt, butylamine salt, dibutylamine salt, tributylamine salt, monoethanol amine salt, diethanol amine salt, triethanol amine salt, N-methyl ethanol amine salt, N-ethyl ethanol amine salt, N,N-dimethyl ethanol amine salt, N,N-diethyl ethanol amine salt, hydroxylamine salt, N,N-diethylhydroxylamine salt, and morpholine salt), quaternary ammonium salt [e.g., tetramethylammonium salt, tetraethylammonium salt, and trimethyl(2-hydroxyethyl)ammonium salt], and alkali metal salt (e.g., sodium salt, and potassium salt).

Among the diols (1′), preferred are the diol (1′) containing a carboxylic acid (salt) group and the diol (1′) containing a sulfonic acid (salt) group, in view of charging ability and heat resistant storage stability of a toner (X).

The crystalline vinyl resin (A3) is a polymer obtained through homopolymerization or copolymerization of a monomer containing a polymerizable double bond. Examples of the monomer containing a polymerizable double bond include the following (5) to (14).

(5) hydrocarbon containing a polymerizable double bond:
(5-1) aliphatic hydrocarbon containing a polymerizable double bond:
(5-1-1) linear-chain hydrocarbon containing a polymerizable double bond:
C2-C30 alkene (e.g., ethylene, propylene, butene, isobutylene, pentene, heptene, diisobutylene, octene, dodecene, and octadecene); C4-C30 alkadiene (e.g., butadiene, isoprene, 1,4-pentadiene, 1,6-hexadiene, and 1,7-octadiene).
(5-1-2) cyclic hydrocarbon containing a polymerizable double bond:
C6-C30 mono or dicycloalkene (e.g., cyclohexene, vinyl cyclohexene, and ethylidene bicycloheptene), and C5-C30 mono or dicycloalkadiene [e.g., (di)cyclopentadiene].
(5-2) aromatic hydrocarbon containing a polymerizable double bond:
styrene; hydrocarbyl (C1-C30 alkyl, cycloalkyl, aralkyl and/or alkenyl) substituent of styrene (e.g., α-methyl styrene, vinyl toluene, 2,4-dimethyl styrene, ethyl styrene, isopropyl styrene, butyl styrene, phenyl styrene, cyclohexyl styrene, benzyl styrene, crotyl benzene, divinyl benzene, divinyl toluene, divinyl xylene, and tri vinyl benzene); and vinyl naphthalene.
(6) a monomer containing a carboxyl group and a polymerizable double bond thereof, and salts thereof:
C3-C15 unsaturated monocarboxylic acid {e.g., (meth)acrylic acid [“(meth)acryl” means acryl or methacryl], crotonic acid, isocrotonic acid, and cinnamic acid}); C3-C30 unsaturated dicarboxylic acid or anhydrides thereof [e.g., maleic acid (anhydride), fumaric acid, itaconic acid, citraconic acid (anhydride), and measaconic acid]; and C3-C10 unsaturated dicarboxylic acid monoalkyl (C1-C10) ester (e.g., monomethyl maleate, monodecyl maleate, monoethyl fumarate, monobutyl itaconate, and monodecyl citraconate).

Examples of the salt constituting the salt of the monomer containing a carboxyl group and a polymerizable double bond include alkali metal salt (e.g., sodium salt, and potassium salt), alkali earth metal salt (e.g., calcium salt, and magnesium salt), ammonium salt, amine salt, and quaternary ammonium salt.

The amine salt is not particularly limited as long as it is an amine compound, and examples thereof include primary amine salt (e.g., ethyl amine salt, butyl amine salt, and octyl amine salt), secondary amine salt (e.g., diethyl amine salt, and dibutyl amine salt), and tertiary amine salt (e.g., triethyl amine salt, and tri butyl amine salt). Examples of the quaternary ammonium salt include tetraethyl ammonium salt, triethyllauryl ammonium salt, tetrabutyl ammonium salt, and tributyllauryl ammonium salt.

Examples of the salt of the monomer containing a carboxyl group and a polymerizable double bond include sodium acrylate, sodium methacrylate, monosodium maleate, disodium maleate, potassium acrylate, potassium methacrylate, monopotassium maleate, lithium acrylate, cesium acrylate, ammonium acrylate, calcium acrylate, and aluminum acrylate.

(7) a monomer containing a sulfo group and a polymerizable double bond, and salts thereof:
C2-C14 alkene sulfonic acid (e.g., vinyl sulfonic acid, (meth)allyl sulfonic acid, and methylvinyl sulfonic acid); styrene sulfonic acid, and an alkyl(C2-C24) derivative thereof (e.g., α-methyl styrene sulfonic acid; C5-C18 sulfo(hydroxy)alkyl(meth)acrylate (e.g., sulfopropyl(meth)acrylate, 2-hydroxy-3-(meth)acryloxypropane sulfonic acid, 2-(meth)acryloyloxyethane sulfonic acid, and 3-(meth)acryloyloxy-2-hydroxypropane sulfonic acid); C5-C18 sulfo(hydroxy)alkyl(meth)acryl amide [e.g., 2-(meth)acryloylamino-2,2-dimethyl ethane sulfonic acid, 2-(meth)acrylamide-2-methylpropane sulfonic acid, and 3-(meth)acrylamide-2-hydroxypropane sulfonic acid]; alkyl(C3-C18)allyl sulfosuccinic acid (e.g., propyl allyl sulfosuccinic acid, butyl allyl sulfosuccinic acid, and 2-ethylhexyl-allyl sulfosuccinic acid); sulfuric acid ester of poly[n(polymerization degree, n represents the same hereinafter)=2 to 30]oxyalkylene (e.g., oxyethylene, oxypropylene, and oxybutylene; oxyalkylene may be used alone or in combination; when used in combination, an added system may be random addition, and block addition) mono(meth)acrylate [e.g., sulfuric acid ester of poly(n=5 to 15)oxyethylene monomethacrylate, and sulfuric acid ester of poly(n=5 to 15)oxypropylene monomethacrylate]; compounds represented by the following general formulae (1) to (3); and salts thereof. Examples of the salt include those listed as the salt for constituting the salt of (6) the monomer containing a carboxyl group and a polymerizable double bond.

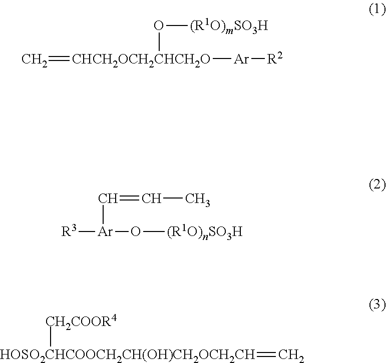

In the formulae above, R¹ is a C2-C4 alkylene group; R¹O may be used as alone, or in combination, and in the case where it is used in combination, a bonding system may be random or block; R² and R³ are each independently a C1-C15 alkyl group; m and n are each independently an integer of 1 to 50; Ar is a benzene ring; R⁴ is a C1-C15 alkyl group, which may be substituted with a fluorine atom.

(8) a monomer containing a phosphono group, and a polymerizable double bond, and salts thereof:
(meth)acryloyloxy alkyl (C1-C24) phosphoric acid monoester (e.g., 2-hydroxyethyl(meth)acryloyl phosphate, and phenyl-2-acryloyloxyethyl phosphate), and (meth)acryloyloxy alkyl (C1-C24) phosphonic acid (e.g., 2-acryloyloxy ethyl phosphonic acid).

Note that, examples of the salt include those listed as the salt constituting (6) monomer containing a carboxyl group and a polymerizable double bond.

(9) a monomer containing a hydroxyl group and a polymerizable double bond:
hydroxy styrene, N-methylol(meth)acryl amide, hydroxyethyl (meth)acrylate, hydroxypropyl (meth)acrylate, polyethylene glycol mono(meth)acrylate, (meth)allyl alcohol, crotyl alcohol, isocrotyl alcohol, 1-buten-3-ol, 2-buten-1-ol, 2-buten-1,4-diol, propargyl alcohol, 2-hydroxyethyl propenyl ether, and sucrose allyl ether.
(10) a nitrogen-containing monomer containing a polymerizable double bond:
(10-1) a monomer containing an amino group and a polymerizable double bond:
Aminoethyl (meth)acrylate, dimethylaminoethyl (meth)acrylate, diethylaminoethyl (meth)acrylate, t-butylaminoethyl methacrylate, N-aminoethyl (meth)acrylamide, (meth)allyl amine, morpholinoethyl (meth)acrylate, 4-vinyl pyridine, 2-vinyl pyridine, crotylamine, N,N-dimethylaminostyrene, methyl-α-acetoaminoacrylate, vinyl imidazole, N-vinyl pyrrole, N-vinyl thiopyrrolidone, N-aryl phenylene diamine, aminocarbazole, aminothiazole, aminoindole, aminopyrrole, aminoimidazole, aminomercaptothiazole, and salts thereof.
(10-2) a monomer containing an amide group and a polymerizable double bond:
(meth)acryl amide, N-methyl(meth)acryl amide, N-butylacrylamide, diacetone acryl amide, N-methylol(meth)acryl amide, N,N′-methylene-bis(meth)acryl amide, cinnamic acid amide, N,N-dimethylacryl amide, N,N-dibenzylacryl amide, methacryl formamide, N-methyl-N-vinyl acetoamide, and N-vinyl pyrrolidone.
(10-3) a C3-C10 monomer containing a nitorile group and a polymerizable double bond:
(meth)acrylonitrile, cyanostyrene, and cyanoacrylate.
(10-4) a C8-C12 monomer containing a nitro group and a polymerizable double bond:
nitrostyrene.
(11) a C6-C18 monomer containing an epoxy group and a polymerizable double bond:
glycidyl (meth)acrylate, and p-vinylphenylphenyloxide.
(12) a C2-C16 monomer containing a halogen atom and a polymerizable double bond:
vinyl chloride, vinyl bromide, vinylidene chloride, acryl chloride, chlorostyrene, bromostyrene, dichlorostyrene, chloromethyl styrene, tetrafluorostyrene, and chloroprene.
(13) ester containing a polymerizable double bond, ether containing a polymerizable double bond, ketone containing a polymerizable double bond, and a sulfur-containing compound containing a polymerizable double bond:
(13-1) C4-C16 ester containing a polymerizable double bond:
vinyl acetate, vinyl propionate, vinyl butyrate, diallyl phthalate, diallyl adipate, isopropenyl acetate, vinyl methacrylate, methyl-4-vinyl benzoate, cyclohexyl methacrylate, benzyl methacrylate, phenyl (meth)acrylate, vinyl methoxy acetate, vinyl benzoate, ethyl-α-ethoxy acrylate, alkyl (meth)acrylate containing a C1-C50 alkyl group [e.g., methyl (meth)acrylate, ethyl (meth)acrylate, propyl (meth)acrylate, butyl (meth)acrylate, 2-ethylhexyl (meth)acrylate, dodecyl (meth)acrylate, hexadecyl (meth)acrylate, heptadecyl (meth)acrylate, and eicosyl (meth)acrylate], dialkyl fumarate (in which two alkyl groups are C2-C8 linear-chain, branched-chain, or alicyclic groups), dialkyl maleate (in which two alkyl groups are C2-C8 linear-chain, branched-chain, or alicyclic groups), poly(meth)allyloxy alkane (e.g., diallyloxy ethane, triallyloxy ethane, tetraallyloxy ethane, tetraallyloxy propane, tetraallyloxy butane, and tetramethallyloxy ethane), a monomer containing a polyalkylene glycol chain and a polymerizable double bond [e.g., polyethylene glycol (Mn=300) mono(meth)acrylate, polypropylene glycol (Mn=500) monoacrylate, methyl alcohol EO(10 mol) adduct (meth)acrylate, and lauryl alcohol EO(30 mol) adduct (meth)acrylate], and poly(meth)acrylate [poly(meth)acrylate of polyhydric alcohol:ethylene glycol di(meth)acrylate, propylene glycol di(meth)acrylate, neopentyl glycol di (meth)acrylate, trimethylol propane tri(meth)acrylate, and polyethylene glycol di(meth)acrylate].
(13-2) C3-C16 ether containing a polymerizable double bond:
vinyl methyl ether, vinyl ethyl ether, vinyl propyl ether, vinyl butyl ether, vinyl-2-ethylhexyl ether, vinyl phenyl ether, vinyl-2-methoxyethyl ether, methoxy butadiene, vinyl-2-butoxyethyl ether, 3,4-dihydro-1,2-pyran, 2-butoxy-2′-vinyloxydiethyl ether, acetoxy styrene, and phenoxy styrene.
(13-3) C4-C12 ketone containing a polymerizable double bond:
vinyl methyl ketone, vinyl ethyl ketone, and vinyl phenyl ketone.
(13-4) C2-C16 sulfur-containing compound containing a polymerizable double bond:
divinyl sulfide, p-vinyldiphenyl sulfide, vinyl ethyl sulfide, vinyl ethyl sulfone, divinyl sulfone, and divinyl sulfoxide.

In view of adhesion strength of a toner (X), among the crystalline resins (A), the crystalline polyester resin (A1) and the crystalline polyurethane resin (A2) are preferable, (A2) is more preferable, (A2-2) containing, as constitutional units thereof, the crystalline polyester resin (A1), the diol (1) and/or diamine (3), and the diisocyanate (4) is even more preferable. The particularly preferred among the (A2-2) is the (A2-2) containing an ester group, urethane group, and urea group in a molecule thereof.

The crystalline resin (A) for use in the present invention may be a block resin containing at least one crystalline segment (a) composed of the aforementioned crystalline resin (A), and at least one non-crystalline segment (a′) composed of the aforementioned non-crystalline resin (A′).

Examples of the non-crystalline resin (A′) for use in the present invention include resins having the same composition as the crystalline polyester resin (A1), crystalline polyurethane resin (A2), and crystalline vinyl resin (A3) listed as examples of the crystalline resin (A), and having a ratio (Tm/Ta) of larger than 1.55, where the ratio is a ratio of Tm to Ta.

In the case where the crystalline resin (A) is a block resin composed of the crystalline segment (a) and the non-crystalline segment (a′), whether or not a binding agent is used is selected considering reactivity of terminal functional groups of both (a) and (a′). In the case where the binding agent is used, the binding agent, which is suited to the terminal functional groups, is selected to bond (a) and (a′), to form a block resin.

In the case where the binding agent is not used, a terminal functional group of (A) to form (a) and a terminal functional group of (A′) to form (a′) are allowed to react optionally with heating and decompressing. Especially in the case of a reaction between acid and alcohol or a reaction between acid and amine, the reaction is carried out smoothly, if an acid value of one resin is high, and a hydroxyl value or amine value of the other resin is high. The reaction temperature for performing reaction is preferably 180° C. to 230° C.

In the case where the binding agent is used, various binding agents can be used. Examples of the binding agent include the aforementioned diol (1), the aforementioned dicarboxylic acid (2), the aforementioned diamine (3), the aforementioned diisocyanate (4), and polyfunctional epoxy.

Examples of the polyfunctional epoxy include: a bisphenol A or bisphenol F epoxy compound; a phenol novolak epoxy compound; a cresol novolak epoxy compound; a hydrogenated bisphenol A epoxy compound; diglycidyl ether of bisphenol A or bisphenol F AO adduct; diglycidyl ether of hydrogenated bisphenol A AO adduct; diglycidyl ether of diol (e.g., ethylene glycol, propylene glycol, neopentyl glycol, butane diol, hexane diol, cyclohexane dimethanol, polyethylene glycol, and polypropylene glycol); trimethylol propane di- and/or triglycidyl ether; pentaerythritol tri- and/or tetraglycidyl ether; sorbitol hepta- and/or hexaglycidyl ether; resorcin diglycidyl ether; dicyclopentadiene-phenol added glycidyl ether; methylene bis(2,7-dihydroxynaphthalene)tetraglycidyl ether, 1,6-dihydroxynaphthalene diglycidyl ether; and polybutadiene diglycidyl ether.

Examples of the method for bonding (a) and (a′) together include a dehydration reaction between (a) and (a′), and an addition reaction between (a) and (a′).

Examples of the dehydration reaction include a reaction where both (a) and (a′) contain hydroxyl groups, and these hydroxyl groups are bonded together with a binding agent [e.g., dicarboxylic acid (2)]. The dehydration reaction can be carried out at reaction temperature of 180° C. to 230° C. in the presence of no solvent.

Examples of the addition reaction include: a reaction where both (a) and (a′) contain hydroxyl groups, and these hydroxyl groups are bonded together with a binding agent [e.g., diisocyanate (4)]; and a reaction where either (a) or (a′) is a resin containing a hydroxyl group, and the other is a resin containing an isocyanate group, and the hydroxyl group and the isocyanate group are bonded together with a binding agent. The addition reaction can be carried out by dissolving (a) and (a′) in a solvent that can dissolve both (a) and (a′), optionally adding a binding agent, and allowing to react at the reaction temperature of 80° C. to 150° C.

In the case where the crystalline resin (A) is a block resin composed of (a) and (a′), the (a) content in (A) is preferably 50% by mass to 99% by mass, more preferably 55% by mass to 98% by mass, even more preferably 60% by mass to 95% by mass, and particularly preferably 62% by mass to 80% by mass. The (a) content falling into the aforementioned range is preferable, as the crystallinity of (A) is not impaired, and excellent low temperature fixing ability, storage stability, and glossiness of (X) are attained.

A total endothermic value of the crystalline resin (A) is preferably 20 J/g to 150 J/g, more preferably 30 J/g to 120 J/g, and even more preferably 40 J/g to 100 J/g. The crystalline resin (A) having the total endothermic value of 20 J/g or greater can improve water resistance of a resulting toner (X), and the crystalline resin (A) having the total endothermic value of 150 J/g or less can give excellent low temperature fixing ability to (X). Accordingly, the crystalline resin (A) having a total endothermic value in the aforementioned range is preferable.

A total endothermic value of (A) can be measured in the following manner.

### [Measuring Method of Total Endothermic Value of (A)]

The measurement is performed by means of a differential scanning calorimeter; e.g., DSC Q1000 (manufactured by TA Instruments) under the following conditions.

Heating rate: 10° C./min
Measurement onset temperature: 20° C.
Measurement offset temperature: 180° C.

As for temperature calibration of a detecting element of the device, melting points of indium and zinc are used. As for the calibration of heat, heat of melting of indium is used.

Specifically, a sample (about 5 mg) is accurately weighted, and placed in a silver pan. The sample is then subjected to a first endothermic value measurement to obtain a DSC curve. From this DSC curve, the total endothermic value of (A) is determined. Note that, an empty silver pan is used as a reference.

Mn of the crystalline resin (A) is preferably 1,000 to 5,000,000, more preferably 2,000 to 500,000.

The Mn and Mw of the resin for use in the present invention are measured by gel permeation chromatography (GPC) under the following conditions.

Device (example): HLC-8120, manufactured by Tosoh Corporation
Column (example): two columns, TSK GEL GMH6, manufactured by Tosoh Corporation
Measuring temperature: 40° C.
Sample solution: 0.25% by mass tetrahydrofuran solution (obtained by filtering and separating an insoluble component)
Solution feeding rate: 100 μl
Detector: refractive index detector
Standard substance: 12 standard poly styrene (TSKstandard POLYSTYRENE) (molecular weights: 500, 1,050, 2,800, 5,970, 9,100, 18,100, 37,900, 96,400, 190,000, 355,000, 1,090,000, 2,890,000)

### [Manufactured by Tosoh Corporation]

The molecular weight distribution (Mw/Mn) of the crystalline resin (A) is 1.0 to 100, more preferably 1.2 to 50, and even more preferably 1.5 to 20. When the molecular weight distribution thereof is within the aforementioned range, low temperature fixing ability and adhesion strength of a toner (X) are improved.

The solubility parameter (referred to as “SP value”, hereinafter) of the crystalline resin (A) is preferably 7 (cal/cm³)^{1/2} to 18 (cal/cm³)^{1/2}, more preferably 8 (cal/cm³)^{1/2} to 16 (cal/cm³)^{1/2}, and even more preferably 9 (cal/cm³)^{1/2} to 14 (cal/cm³)^{1/2}. Note that, the SP value in the present invention can be calculated in accordance with the Fedors method [Polym. Eng. Sci. 14(2)152, (1974)].

The glass transition temperature (abbreviated as “Tg” hereinafter) of the crystalline resin (A) is preferably 20° C. to 200° C., more preferably 40° C. to 150° C. When Tg thereof is 20° C. or higher, excellent storage stability of the toner particles can be achieved. Note that, Tg can be measured by means of, for example, DSC20, SSC/580 (manufactured by Seiko Instruments Inc.) in accordance with the method (DSC) specified in ASTM D3418-82.

### <Shell Phase (S)>

The shell phase (S) contains at least a crystalline polyurethane resin (B).

### <<Crystalline Polyurethane Resin (B)>>

Examples of the crystalline polyurethane resin (B) for use in the present invention include the ones having the same composition as that of the crystalline polyurethane resin (A2).

The maximum peak temperature of heat of melting (abbreviated as “Tu” hereinafter) of the crystalline polyurethane resin (B) is 50° C. to 90° C. In view of the minimum fixing temperature and heat resistant storage stability, Tu thereof is preferably 53° C. to 87° C., more preferably 53° C. to 85° C., and even more preferably 55° C. to 83° C. When Tu of (B) is lower than 50° C., heat resistant storage stability of a toner (X) is impaired. When Tu thereof is higher than 90° C., the minimum fixing temperature of (X) elevates. Accordingly, Tu of (B) being lower than 50° C. and higher than 90° C. is not preferable.

The crystalline polyurethane resin (B) preferably satisfies the following condition 2. The crystalline polyurethane resin (B) satisfying the condition 2 can contribute to an improvement in adhesion strength of a toner (X).

5≦0.94(B-urethane)+0.70(B-urea)+0.00032(B-Mw)−9.2 [Condition 2]

In the condition 2, (B-urethane) is a urethane group concentration (% by mass) of (B).

In the condition 2, (B-urea) is a urea group concentration (% by mass) of (B).

In the condition 2, (B-Mw) is Mw of (B).

In the present invention, (B-urethane) and (B-urea) in (B) are calculated from an N atom content determined by a nitrogen analyzer (ANTEK7000, manufactured by Antec, Inc.), and a ratio between urethane groups and urea groups determined by NMR.

Note that, in the case where an amine compound is used as a catalyst and/or additive in the production of (B), the value associated with such amine compound needs to be subtracted from the measurement value. When the used amine compound has a boiling point of lower than 70° C., a method where a sample is dried for 2 hours at 130° C. under the reduced pressure, and then subjected to the measurement can be used. When the used amine compound has a boiling point of 70° C. or higher, moreover, used is a method where a sample is subjected to the measurement as it is, and the value obtained by subtracting the N atom content calculated from the loaded amount of the amine compound from the N atom content as measured is determined as the N atom content.

The NMR measurement can be performed in accordance with the method disclosed in “Structural Study of Polyurethane Resin by NMR: Journal of the Takeda Research Laboratories 34(2), 224-323 (1975).” Specifically, a H¹-NMR analysis is performed to determine a mass ratio of urea groups and urethane groups from a ratio of an integration value of hydrogen originated from a urea group adjacent to the chemical shift 6 ppm and an integration value of hydrogen originated from a urethane group adjacent to the chemical shift 7 ppm, and an amount of urea groups and an amount of urethane groups are calculated from the mass ratio and the aforementioned N atom content. The urea group content and urethane group content can be adjusted by appropriately adjusting a composition of raw materials, and equivalent amounts thereof to be loaded.

In view of adhesion strength of a toner (X), the lower limit in the condition 2 is more preferably 5.5, and even more preferably 6.0. (B-urethane) in the condition 2 is preferably 1.0% by mass to 30% by mass, more preferably 2.0% by mass to 20% by mass. (B-urea) in the condition 2 is preferably 0.05% by mass to 5% by mass, more preferably 0.1% by mass to 2% by mass. (B-Mw) in the condition 2 is preferably 5,000 to 100,000, more preferably 10,000 to 70,000.

An acid value of the crystalline polyurethane resin (B) is preferably 5 (mgKOH/g) to 200 (mgKOH/g), more preferably 10 (mgKOH/g) to 150 (mgKOH/g), and even more preferably 15 (mgKOH/g) to 100 (mgKOH/g). When the acid value of (B) is 5 (mgKOH/g) or higher, resin particles (E) containing (B) are easily dispersed in a continuous phase medium (O) in the below-described production method of a toner (X). In addition, an emulsion is easily formed. When the acid value of (B) is 200 (mgKOH/g) or lower, excellent water resistance of a toner (X) can be achieved.

Note that, the acid value of (B) can be measured by the method specified in JIS K0070.

The SP value of the crystalline polyurethane resin (B) is preferably 9.0 (cal/cm³)^{1/2} to 14 (cal/cm³)^{1/2}, more preferably 9.5 (cal/cm³)^{1/2} to 13 (cal/cm³)^{1/2}, and even more preferably 9.8 (cal/cm³)^{1/2} to 12 (cal/cm³)^{1/2}.

The toner (X) of the present invention contains toner particles, each of which contains a shell phase (S) containing the crystalline polyurethane resin (B) on a surface of a core phase (Q) containing the crystalline resin (A). A mass ratio [(Q):(S)] of the core phase (Q) to the shell phase (S) is preferably 99.9:0.1 to 75:25, more preferably 99.5:0.5 to 80:20, and even more preferably 99:1 to 90:10.

The toner (X) of the present invention preferably satisfies the following condition 1.

0≦(Tu)−(Ta)≦30(° C.) [Condition 1]

In the condition 1, the closer the value of (Tu)−(Ta) to the upper limit is, more excellent heat resistant stability of the toner (X) is achieved. The closer the value of (Tu)−(Ta) to the lower limit is, excellent low temperature fixing ability of the toner (X) is achieved.

The lower limit in the condition 1 is preferably 5° C., more preferably 10° C. The upper limit in the condition 1 is preferably 25° C., more preferably 20° C.

The volume average particle diameter of the toner (X) is preferably 0.0005 μm to 30 μm, more preferably 0.01 μm to 20 μm, and even more preferably 0.02 μm to 10 μm. Note that, the volume average particle diameter of (X) can be measured by means of a laser particle size distribution analyzer, such as LA-920 manufactured by HORIBA, Ltd., and Multisizer III manufactured by Bechman Coulter, Inc., or ELS-800 manufactured by Otsuka Electronics Co., Ltd., which uses a laser Doppler method as an optical system, or LB-550 manufactured by Shimadzu Corporation, which uses a light scattering method.

In view of flowability and melt-leveling of the toner (X), the average circularity of the toner (X) is preferably 0.96 to 1.0, more preferably 0.97 to 1.0, and even more preferably 0.98 to 1.0. Note that, the average circularity of (X) is the value obtained by optically detecting the particles, and dividing a circumferential length of the actual particle by a circumferential length of an equivalent circle having the same projection area to that of the toner. The value thereof closer to 1.0 means that the shape of the particle is closer to sphere. The average circularity of (X) can be measured by means of a flow particle analyzer (FPIA-2000, manufactured by Sysmex Corporation.

### (Method for Producing Toner (X))

A method for producing a toner (X) is not particularly limited, but use of the method for producing a toner (X) of the present invention can provide a toner having an excellent particle size distribution.

The method for producing a toner (X) of the present invention contains: dispersing a solution (D), which is prepared by dissolving a crystalline resin (A) in an organic solvent (C), in a dispersion medium (F), which is prepared by dispersing resin particles (E) each containing a crystalline polyurethane resin (B), to thereby obtain a dispersion liquid (DF); and removing the organic solvent (C) and the dispersion medium (F) from the dispersion liquid (DF), and depositing the resin particles (E) on surfaces of toner core particles (G) each containing the crystalline resin (A), to thereby form a shell phase (S) containing the crystalline polyurethane resin (B) on a surface of a core phase (Q) containing the crystalline resin (A), wherein maximum peak temperature (Ta) of heat of melting of the crystalline resin (A) is 40° C. to 70° C., and maximum peak temperature (Tu) of heat of melting of the crystalline polyurethane resin (B) is 50° C. to 90° C.

The crystalline resin (A), crystalline polyurethane resin (B), Ta of (A), Tu of (B) in the method for producing a toner (X) of the present invention are the same to those mentioned earlier, and the preferable ranges thereof are the same to the ones described earlier.

In the method for producing a toner (X) of the present invention, as for the crystalline resin (A), the one obtained from the precursor (A0) thereof may be used. The precursor (A0) is not particularly limited as long as it can become a resin (A) as a result of a chemical reaction. In the case where (A) is the crystalline polyester resin (A1) or crystalline polyurethane resin (A2), examples of (A0) include a combination of a prepolymer (α) containing a reactive group, and a curing agent (β). In the case where (A) is the crystalline vinyl resin (A3), examples of (A0) include the aforementioned monomers (5) to (14). In view of adhesion strength, preferred among (A0) is a combination of a prepolymer (α) containing a reactive group and a curing agent (β).

In the case where a combination of a prepolymer (α) and a curing agent (β) is used as the precursor (A0), the “reactive group” contained in (α) means a group reactive with a curing agent (β). In this case, examples for reacting the precursor (A0) to form (A) include a method where (α) and (β) are dispersed in the below-mentioned dispersion medium (W), and (α) and (β) are allowed to react by heating, to thereby form (A).

Examples of the combination of a reaction group contained in the reactive group-containing prepolymer (α) and the curing agent (β) include the following [1] and [2].

[1] The combination in which the reactive group contained in (α) is a functional group (α1) reactive with an active hydrogen compound, and (β) is an active hydrogen group-containing compound (β1).
[2] The combination in which a reactive group contained in (α) is an active hydrogen-containing group (α2), and (β) is a compound (β2) reactive with the active hydrogen-containing group.

In the combination [1], examples of the functional group (α1) reactive with an active hydrogen compound include an isocyanate group (α1a), a blocked isocyanate group (α1b), an epoxy group (α1c), an acid anhydride group (α1d), and an acid halide group (α1e). Among them, preferred are (α1a), (α1b), and (α1c), and more preferred are (α1a) and (α1b).

The blocked isocyanate group (α1b) is an isocyanate group blocked with a blocking agent.

Examples of the blocking agent include: oxime (e.g., acetoxime, methylisobutyl ketoxide, diethyl ketoxide, cyclopentanone oxime, cyclohexanone oxime, and methylethyl ketoxide); lactam (e.g., γ-butyrolactam, ε-caprolactam, and γ-valerolactam); C1-C20 aliphatic alcohol (e.g., ethanol, methanol, and octanol); phenol (e.g., phenol, m-cresol, xylenol, and nonyl phenol); an active methylene compound (e.g., acetyl acetone, ethyl malonate, and acetoethyl acetate); a basic nitrogen-containing compound (e.g., N,N-diethylhydroxyl amine, 2-hydroxypyridine, pyridine N-oxide, and 2-mercaptopyridine); and a mixture thereof.

Among them, oxime is preferable, and methylethyl ketoxide is more preferable.

Examples of the constitutional unit of the reactive group-containing prepolymer (α) include polyether (αw), polyester (αx), an epoxy resin (αy), and polyurethane (αz). Among them, preferred are (αx), (αy) and (αz), and more preferred are (αx) and (αz).

Examples of the polyether (αw) include polyethylene oxide, polypropylene oxide, polybutylene oxide, and polytetramethylene oxide.

Examples of the polyester (αx) include a polycondensation product of the diol (1) and the dicarboxylic acid (2), and polylactone (e.g., a ring-opening polymerization product of ε-caprolactone).

Examples of the epoxy resin (αy) include an addition condensation product of bisphenol (e.g., bisphenol A, bisphenol F, and bisphenol S) and epichlorohydrin.

Examples of the polyurethane (αz) include a polyaddition product of diol (1) and diisocyanate (4), and a polyaddition product of polyester (αx) and diisocyanate (4).

Examples of the method for introducing a reactive group into the polyester (αx), epoxy resin (αy) or polyurethane (αz) include:

[1] a method containing excessively using one constitutional unit out of two or more constitutional units to leave a functional group of the constitutional unit at a terminal; and
[2] a method containing excessively using one constitutional unit out of two or more constitutional units to leave a functional group of the constitutional unit at terminal, and allowing a functional group reactive with the left functional group, and a compound containing a reactive group to react.

In accordance with the method of [1], obtainable are hydroxyl group-containing polyester prepolymer, carboxyl group-containing polyester prepolymer, acid halide group-containing polyester prepolymer, hydroxyl group-containing epoxy resin prepolymer, epoxy group-containing epoxy resin prepolymer, hydroxyl group-containing polyurethane prepolymer, and isocyanate group-containing polyurethane prepolymer.

For example, in the case of hydroxyl group-containing polyester prepolymer, a blending ratio of constitutional components, i.e., a polyol component, and a polycarboxylic acid component, is determined as an equivalent ratio [OH]/[COOH] of hydroxyl groups [OH] to carboxyl groups [COOH], which is preferably 2/1 to 1/1, more preferably 1.5/1 to 1/1, and even more preferably 1.3/1 to 1.02/1. In case of prepolymer having another skeleton and terminal group, the ratio is the same with different constitutional components.

In the method of [2], the prepolymer obtained in the method [1] is allowed to react with polyisocyanate to obtain isocyanate group-containing prepolymer; the prepolymer obtained in the method [1] is allowed to react with blocked polyisocyanate to obtain blocked isocyanate group-containing prepolymer; the prepolymer obtained in the method [1] is allowed to react with polyepoxide to obtain epoxy group-containing prepolymer; and the prepolymer obtained in the method [1] is allowed to react with polyacid anhydride to obtain acid anhydride group-containing prepolymer.

For example, in the case where hydroxyl group-containing polyester is allowed to react with polyisocyanate to obtain isocyanate group-containing polyester prepolymer, amounts of the functional group, and the compound containing a reactive group for use are determined, for example, as follow. A ratio of polyisocyanate is determined as an equivalent ratio [NCO]/[OH] of isocyanate groups [NCO] to hydroxyl groups [OH] of the hydroxyl group-containing polyester, which is preferably 5/1 to 1/1, more preferably 4/1 to 1.2/1, and even more preferably 2.5/1 to 1.5/1. In case of the prepolymer having other skeleton and a terminal group, the ratio is the same with different constitutional components.

The number of reactive groups contained per molecule of the reactive group-containing prepolymer (α) is preferably 1 or greater, more preferably 1.5 to 3 on average, and even more preferably 1.8 to 2.5 on average. When the number of the reactive groups is within the aforementioned range, a molecular weight of a cured product obtained through a reaction with the curing agent (β) becomes high.

The Mn of the reactive group-containing prepolymer (α) is preferably 500 to 30,000, more preferably 1,000 to 20,000, and even more preferably 2,000 to 10,000.

The Mw of the reactive group-containing prepolymer (α) is preferably 1,000 to 50,000, more preferably 2,000 to 40,000, and even more preferably 4,000 to 20,000.

The viscosity of the reactive group-containing prepolymer (α) at 100° C. is preferably 200 Pa·s or less, more preferably 100 Pa·s or less. By controlling the viscosity thereof to 200 Pa·s or less, a toner (X) having a narrow particle size distribution can be attained, and therefore such range of the viscosity is preferable.

Examples of the active hydrogen group-containing compound (β1) include diamine (β1a), which may be blocked with a leavable compound, diol (Bib), dimercaptan (β1c), and water. Among them, (β1a), (β1b), and water are preferable, (β1a) and water are more preferable, and blocked polyamine, and water are even more preferable.

Examples of (β1a) include the ones same as the diamine (3). Preferred as (β1a) are 4,4′-diaminodiphenylmethane, xylene diamine, isophorone diamine, ethylene diamine, diethylene triamine, triethylene tetramine, and a mixture thereof.

Examples of polyamine blocked with a leavable compound as (β1a) include a ketimine compound formed between the polyamine and C3-C8 ketone (e.g., acetone, methylethyl ketone, and methylisobutyl ketone), an aldimine compound between the polyamine and a C2-C8 aldehyde compound (e.g., formaldehyde, and acetoaldehyde), an enamine compound, and an oxazolidine compound.

Examples of the diol (Bib) include the one same as the diol (1). The preferable ranges associated with the diol are also the same. Examples of the dimercaptan (β1c) include ethylene dithiol, 1,4-butane dithiol, and 1,6-hexane dithiol.

Optionally, a reaction terminator (βs) can be used together with the active hydrogen group-containing compound (β1). Use of the reaction terminator together with (β1) at a certain ratio, a molecular weight of (A) can be controlled to the predetermined molecular weight.

Examples of the reaction terminator (βs) include: monoamine (e.g., ethyl amine, dibutyl amine, butyl amine, lauryl amine, monoethanol amine, and ethanol amine); a blocked product of the monoamine (e.g., a ketimine compound); monool (e.g., methanol, ethanol, isopropanol, butanol, and phenol); monomercaptan (e.g., butyl mercaptan, and lauryl mercaptan); monoisocyanate (e.g., lauryl isocyanate, and phenyl isocyanate); and monoepoxide (e.g., butylglycidyl ether).

Examples of the active hydrogen-containing group (α2) contained in the reactive group-containing prepolymer (α) in the combination [2] include an amino group (α2a), a hydroxyl group (e.g., an alcoholic hydroxyl group, and a phenolic hydroxyl group) (α2b), a mercapto group (α2c), a carboxyl group (α2d), and an organic group (α2e) blocked with a leavable compound. Among them, (α2a), (α2b), and (α2e) are preferable, and (α2b) is more preferable.

Examples of the organic group, in which an amino group is blocked with a leavable compound, include those listed in the case of (β1a).

Examples of the compound (82) reactive with an active hydrogen-containing group include diisocyanate (β2a), polyepoxide (β2b), polycarboxylic acid (β2c), polyacid anhydride (β2d), and polyacid halide (β2e). Among them, (β2a) and (β2b) are preferable, and (β2a) is more preferable.

Examples of the diisocyanate (β2a) include the ones same as the diisocyanate (4), and preferable examples thereof are also the same.

Examples of the diepoxide (β2b) include an aromatic diepoxy compound, and an aliphatic diepoxy compound.

Examples of the aromatic diepoxy compound include glycidyl ether of polyhydric phenol, glycidyl ester of polyhydric phenol, glycidyl aromatic polyamine, and a glycidylation product of aminophenol.

Examples of the glycihyl ether of polyhydric phenol include bisphenol F diglycidyl ether, bisphenol A diglycidyl ether, bisphenol B diglycidyl ether, bisphenol AD diglycidyl ether, bisphenol S diglycidyl ether, halogenated bisphenol A diglycidyl, tetrachlorobisphenol A diglycidyl ether, catechin diglycidyl ether, resorcinol diglycidyl ether, hydroquinone diglycidyl ether, pyrogallol triglycidyl ether, 1,5-dihydroxynaphthalene diglycidyl ether, dihydroxybiphenyl diglycidyl ether, octachloro-4,4′-dihydroxybiphenyl diglycidyl ether, tetramethylbiphenyl diglycidyl ether, dihydroxynaphthylcresol triglycidyl ether, tris(hydroxyphenyl)methane triglycidyl ether, dinaphthyltriol triglycidyl ether, tetrakis(4-hydroxyphenyl)ethane tetraglycidyl ether, p-glycidylphenyldimethyltryl bisphenol A glycidyl ether, trismethyl-t-butyl-butylhydroxymethane triglycidyl ether, 9,9′-bis(4-hydroxyphenyl)fluorene diglycidyl ether, 4,4′-oxybis(1,4-phenylethyl)tetracresol glycidyl ether, 4,4′-oxybis(1,4-phenylethyl)phenylglycidyl ether, bis(dihydroxynaphthalene) tetraglycidyl ether, glycidyl ether of a phenol or cresol novolak resin, glycidyl ether of a limonene phenol novolak resin, diglycidyl ether obtained through a reaction between bisphenol A (2 mol) and epichlorohydrin (3 mol), polyglycidyl ether of polyphenol obtained through a condensation reaction between phenol with glyoxal, glutaraldehyde, or formaldehyde, and polyglycidyl ether of polyphenol obtained through a condensation reaction between resorcin and acetone.

Examples of the glycidyl ester of polyhydric phenol include diglycidyl phthalate, diglycidyl isophthalate, and diglycidyl terephthalate.

Examples of the glycidyl aromatic polyamine include N,N-diglycidylaniline, N,N,N′,N′-tetraglycidylxylylene diamine, and N,N,N′,N′-tetraglycidyldiphenylmethane diamine.

Moreover, examples of the aromatic polyepoxy compound include triglycidyl ether of p-aminophenol, a diglycidyl urethane compound obtained through an addition reaction between tolylene diisocyanate or phenylmethane diisocyanate, and glycidol, a glycidyl group-containing polyurethane (pre)polymer obtained by reacting the aforementioned two reaction products with polyol, and diglycidyl ether of bisphenol A AO adduct.

Examples of the aliphatic polyepoxy compound include a linear-chain aliphatic polyepoxy compound, and a cyclic aliphatic polyepoxy compound.

Examples of the linear-chain aliphatic polyepoxy compound include polyglycidyl ether of polyhydric aliphatic alcohol, polyglycidyl ester of polyvalent fatty acid, and glycidyl aliphatic amine.

Examples of the polyglycidyl ether of polyhydric aliphatic alcohol include ethylene glycol diglycidyl ether, propylene glycol diglycidyl ether, tetramethylene glycol diglycidyl ether, 1,6-hexanediol diglycidyl ether, polyethylene glycol diglycidyl ether, polypropylene glycol diglycidyl ether, polytetramethylene glycol diglycidyl ether, neopentylglycol diglycidyl ether, trimethylolpropane polyglycidyl ether, glycerol polyglycidyl ether, pentaerythritol polyglycidyl ether, sorbitol polyglycidyl ether, and polyglycerol polyglycidyl ether.

Examples of the polyglycidyl ester of polyvalent fatty acid include diglycidyl oxalate, diglycidyl maleate, diglycidyl succinate, diglycidyl glutarate, diglycidyl adipate, and diglycidyl pimelate.

Examples of the glycidyl aliphatic amine include N,N,N′,N′-tetraglycidylhexamethylene diamine.

Moreover, examples of the aliphatic polyepoxy compound include a copolymer of diglycidyl ether, and glycidyl (meth)acrylate.

Examples of the cyclic aliphatic polyepoxy compound include trisglycidyl melamine, vinylcyclohexene dioxide, limonene dioxide, dicyclopentadiene dioxide, bis(2,3-epoxycyclopentyl)ether, ethylene glycol bisepoxydicyclopentyl ether, 3,4-epoxy-6-methylcyclohexylmethyl-3′,4′-epoxy-6′-methylcyclohexane carboxylate, bis(3,4-epoxy-6-methylcyclohexylmethyl) adipate, bis(3,4-epoxy-6-methylcyclohexylmethyl) butylamine, and dimer acid diglycidyl ester.

Moreover, examples of the cyclic aliphatic polyepoxy compound include a hydrogenated product of the aromatic polyepoxide compound.

Examples of the dicarboxylic acid (β2c) include the ones the same as the dicarboxylic acid (2), and preferable examples thereof are also the same.

A ratio of the curing agent (β) is determined as a ratio [α]/[β] of an equivalent amount of reactive groups [α] in the reactive group-containing prepolymer (α) to an equivalent amount of active hydrogen containing groups [6] in the curing agent (β). The ratio [α]/[β] is preferably 1/2 to 2/1, more preferably 1.5/1 to 1/1.5, and even more preferably 1.2/1 to 1/1.2. Note that, in the case where the curing agent (β) is water, water is treated as a bivalent active hydrogen compound.

In the case where (A) is the crystalline vinyl resin (A3), and the monomers (5) to (14) are used as (A0), examples of a method for reacting the precursor (A0) to form (A) include a method containing dispersing and suspending, in a dispersion medium (W), an oil phase containing an oil-soluble initiator, and a monomer, and performing a radical polymerization reaction with heating.

Examples of the oil-soluble initiator include an oil-soluble peroxide-based polymerization initiator (I), and an oil-soluble azo-based polymerization initiator (II). Moreover, the oil-soluble peroxide-based polymerization initiator (I) and a reducing agent may be used in combination to form a redox-based polymerization initiator (III). Moreover, two or more selected from (I) to (III) may be used in combination.

The oil-soluble peroxide-based polymerization initiator (I) includes:

acetyl peroxide, t-butylperoxy-2-ethylhexanoate, benzoyl peroxide, parachlorobenzoyl peroxide, and cumene peroxide.

The oil-soluble azo-based polymerization initiator (II) includes:

2,2′-azobisisobutyronitrile, 2,2′-azobis-2,4-dimethylvaleronitrile, dimethyl-2,2′-azobis(2-methylpropionate), and 2,2′-azobis(4-methoxy-2,4-dimethylvaleronitrile).

The nonaqueous redox-based polymerization initiator (III) includes:

a combination of oil-soluble peroxide (e.g., hydroperoxide, dialkyl peroxide, and diacyl peroxide), and an oil-soluble reducing agent, such as tertiary amine, naphtheric acid salt, mercaptan, and an organic metal compound (e.g., triethyl aluminum, boron triethyl, and zinc diethyl).

In the method for producing a toner (X) of the present invention, the crystalline polyurethane resin (B) preferably contains, in addition to the diol (1), a diol (1′) as constitutional units thereof, where the diol (1′) contains at least one group selected from the group consisting of a carboxylic acid salt group, a sulfonic acid salt group, a sulfamic acid salt group, and a phosphoric acid salt group. (B) having the diol (1′) as a constitutional unit thereof is preferable, as the resin particles (E) are easily dispersed in a dispersion medium (F).

In the case where the crystalline polyurethane resin (B) contains, as a constitutional unit thereof, diol (1′) containing at least one group selected from the group consisting of a carboxylic acid salt group, a sulfonic acid salt group, a sulfamic acid salt group, and a phosphoric acid salt group, the method for producing a toner (X) of the present invention preferably contains, after dispersing the solution (D) in the dispersion medium (F) in which resin particles (E) each containing the crystalline polyurethane resin (B) to obtain the dispersion liquid (DF), transforming at least one group selected from the group consisting of a carboxylic acid salt group, a sulfonic acid salt group, a sulfamic acid salt group, and a phosphoric acid salt group contained in the resin particles (E) into at least one group selected from the group consisting of a carboxylic acid group, a sulfonic acid group, a sulfamic acid group, and a phosphoric acid group. By including the aforementioned step in the production method, low temperature fixing ability and water resistance of the obtained toner (X) are improved.

The method for transforming at least one group selected from the group consisting of a carboxylic acid salt group, a sulfonic acid salt group, a sulfamic acid salt group, and a phosphoric acid salt group contained in (E) into at least one group selected from the group consisting of a carboxylic acid group, a sulfonic acid group, a sulfamic acid group, and a phosphoric acid group is particularly limited, as long as an acidic aqueous solution is used. The acidic aqueous solution for use can be appropriately selected from compounds known in the art. Examples thereof include an aqueous solution of hydrochloric acid, an aqueous solution of acetic acid, an aqueous solution of phosphoric acid, and an aqueous solution of nitric acid. These may be used alone, or in combination. Among them, hydrochloric acid, and phosphoric acid are preferable.

Examples of the organic solvent (C) for use in the present invention include: an aromatic hydrocarbon solvent (e.g., toluene, xylene, ethyl benzene, and tetralin); an aliphatic hydrocarbon solvent (e.g., n-hexane, n-heptane, n-decane, mineral spirit, and cyclohexane); a halogen solvent (e.g., methyl chloride, methyl bromide, methyl iodide, methylene dichloride, carbon tetrachloride, trichloroethylene, and perchloroethylene); an ester solvent (e.g., ethyl acetate, butyl acetate, methyl 2-hydroxyisobutyrate, methyl lactate, ethyl lactate, methoxybutyl acetate, methyl cellosolve acetate, ethyl cellosolve acetate, methyl pyruvate, and ethyl pyruvate); an ether solvent (e.g., diethyl ether, tetrahydrofuran, dioxane, dioxolane, ethyl cellosolve, butyl cellosolve, ethylene glycol monomethyl ether, ethylene glycol monoethyl ether, propylene glycol monomethyl ether, and propylene glycol monoethyl ether); a ketone solvent (e.g., acetone, methyl ethyl ketone, methyl isobutyl ketone, di-n-butyl ketone, and cyclohexanone); an alcohol solvent (e.g., methanol, ethanol, n-propanol, isopropanol, n-butanol, isobutanol, t-butanol, 2-ethylhexyl alcohol, benzyl alcohol, 2,2,3,3-tetrafluoropropanol, and trifluoro ethanol); an amide solvent (e.g., dimethyl formamide, and dimethyl acetoamide); a sulfoxide solvent (e.g., dimethyl sulfoxide); a heterocycloc compound solvent (e.g., N-methylpyrrolidone); and a mixed solvent thereof. Moreover, a mixed solvent containing any of these organic solvent and an alcohol solvent or water may be used.

The solution (D) for use in the present invention is obtained by dissolving the crystalline resin (A) in the organic solvent (C).

The (A) content in the (D) is preferably 5% by mass to 50% by mass, more preferably 10% by mass to 40% by mass. The (C) content in the (D) is preferably 40% by mass to 90% by mass, more preferably 50% by mass to 85% by mass.

The solution (D) may further contain additives (e.g., a colorant, a charge controlling agent, an antioxidant, a blocking agent, a heat resistant stabilizer, and a flow improving agent).

As for the colorant, any dye or pigment used as a colorant for a toner can be used. Specific examples thereof include carbon black, iron black, Sudan Black SM, Fast Yellow G, benzidine yellow, Solvent Yellow (21, 77, 114 etc.), Pigment Yellow (12, 14, 17, 83 etc.), Indofast Orange, Irgazin Red, p-nitroaniline red, toluidine red, Solvent Red (17, 49, 128, 5, 13, 22, 48-2 etc.), disperse red, Carmine FB, Pigment Orange R, Lake Red 2G, Rhodamine FB, Rhodamine B Lake, Methyl Violet B Lake, phthalocyanine blue, Solvent Blue (25, 94, 60, 158-3 etc.), Pigment Blue, brilliant green, phthalocyanine green, Oil Yellow GG, Kayaset YG, Orasol Brown B, and Oil Pink OP. These may be used alone, or in combination. An amount of the colorant is preferably 0.5% by mass to 15% by mass relative to a mass of (A).

Examples of the charge controlling agent include a nigrosine dye, a triphenylmethane-based dye containing tertiary amine as a side chain thereof, quaternary ammonium salt, a polyamine resin, an imidazole derivative, quaternary ammonium salt group-containing polymer, a metal-containing azo dye, a copper phthalocyanine dye, salicylic acid metal salt, a boron complex of benzoic acid, sulfonic acid group-containing polymer, fluoropolymer, halogen-substituted aromatic ring-containing polymer, a metal complex of an alkyl derivative of salicylic acid, and cetyltrimethylammonium bromide. An amount of the charge controlling agent is preferably 0% by mass to 5% by mass, relative to a mass of the (A).

Examples of the flow improving agent include colloidal silica, alumina powder, titanium oxide powder, calcium carbonate powder, barium titanate, magnesium titanate, calcium titanate, strontium titanate, zinc oxide, quartz sand, clay, mica, wollastonite, diatomaceous earth, chromic oxide, cerium oxide, red iron oxide, antimony trioxide, magnesium oxide, zirconium oxide, barium sulfate, and barium carbonate. An amount of the flow improving agent is 0% by mass to 10% by mass, relative to a mass of (A).

The resin particles (E) for use in the present invention contain the crystalline polyurethane resin (B). The volume average particle diameter of (E) is preferably 0.01 μm to 0.5 μm, more preferably 0.02 μm to 0.4 μm, even more preferably 0.03 μm to 0.3 μm, and even more preferably 0.04 μm to 0.2 μm.

The toner core particles (G) for use in the present invention contain the crystalline resin (A). The volume average particle diameter of (G) is preferably 0.1 μm to 300 μm, more preferably 0.5 μm to 250 μm, and even more preferably 1 μm to 200 μm.

The volume average particle diameters of the resin particles (E) and (G) can be measured by a laser particle size distribution analyzer, such as LA-920 manufactured by HORIBA, Ltd., and Multisizer III manufactured by Bechman Coulter, Inc., or ELS-800 manufactured by Otsuka Electronics Co., Ltd., which uses a laser Doppler method as an optical system. If there is a difference in the measured values between the aforementioned measuring devices, the measured value of ELS-800 is used.

The volume average particle diameter of the resin particles (E) is typically smaller than the volume average particle diameter of the toner core particles (G). In view of uniformity in the particle diameter of the toner (X), a value of the particle diameter ratio [the volume average particle diameter of (E)]/[the volume average particle diameter of (G)] is preferably in the range of 0.001 to 0.3. The lower limit of the particle diameter ratio is more preferably 0.003, and the upper limit thereof is more preferably 0.25. When the particle diameter ratio is greater than 0.3, (E) is not sufficiently adsorbed on a surface of (G), and therefore a particle size distribution of the toner (X) tends to be wide.

Examples of the dispersion medium (F) for use in the present invention include fluid or supercritical carbon dioxide (F1), a nonaqueous organic solvent (F2), and an aqueous medium (F3). Among (F1), the fluid carbon dioxide is carbon dioxide having the temperature and pressure conditions represented in the region in a phase diagram represented with temperature and pressure axes of the carbon dioxide, where surrounded by a gas-fluid boundary line passing through a triple point of carbon dioxide (temperature: −57° C., pressure: 0.5 MPa) and a critical point of carbon dioxide (temperature: 31° C., pressure: 7.4 MPa), an equivalent temperature line of critical temperature, and a solid-fluid boundary line.

Among (F1), the supercritical carbon dioxide is carbon dioxide having temperature and pressure conditions equal to or higher than the critical temperature (with proviso that the pressure represents total pressure in case of a mixed gas composed of two or more components).

Examples of the nonaqueous organic solvent (F2) include an organic solvent, to which a solubility of the crystalline resin (A) is 1% by mass or less, among the aforementioned organic solvent (C). The solubility of (A) being 1% by mass or less is preferable, as toner particles of the toner (X) are not easily cohered. Note that, the solubility of (A) to (F2) can be measured in the following method.

A nonaqueous dispersion liquid prepared by dispersing 10 g of (A) in 90 g of (F2) is subjected to centrifugal separation for 10 minutes at 3,000 rpm. A resulting supernatant liquid (about 2 g (wg)) is collected in an aluminum container. Then, the supernatant liquid is dried by means of a vacuum dryer at temperature equal to a boiling point of (C) for 1 hour. A mass of the resulting residue is weighted. Determining the residue mass as Wg, the solubility of (A) to (F2) can be calculated from the following equation.

Solubility(% by mass)=[(W/w)/10]×100

Moreover, the boiling point of (F2) is preferably higher than the boiling point of the organic solvent (C) for use in the method for producing a toner (X), by 20° C. or greater. Use of such (F2) can prevent (F2) from being removed in the process of removing (C) by decompressing.

The aqueous medium (F3) is not particularly limited, as long as it is a liquid containing water as an essential constitutional component. Examples of (F3) include a solution prepared by adding a surfactant to water. As for the surfactant, a conventional surfactant (e.g., the surfactant disclosed in JP-A No. 2004-124059) can be used. On the other hand, there is also a case where (F3) preferably contains no surfactant in view of a cost of the toner (X) and environmental load.

The process for dispersing the solution (D) in the dispersion medium (F) to obtain the dispersion liquid (DF) in the present invention is not particularly limited, and examples thereof include a method for dispersing (D) in (F) by means of a disperser.

The disperser is not particularly limited, as long as it is a disperser typically on the market as an emulsifier or a disperser. Examples thereof include a batch emulsifier (e.g., Homogenizer manufactured by IKA, POLYTRON manufactured by KINEMATICA AG., and TK Auto Homomixer manufactured by PRIMIX Corporation), a continuous emulsifier (e.g., Ebara Milder manufactured by Ebara Corporation, TK FILMIX and TK Pipeline Homo Mixer manufactured by PRIMIX Corporation, Colloid Mill manufactured by Shinko Pantech, Slusher and Trigonal Wet Mill manufactured by Suntec Co., Ltd., Capitron manufactured by Eurotech, and Fine Flow Mill manufactured by Pacific Machinery & Engineering Co., Ltd.), a high pressure emulsifier (e.g., Microfluidizer manufactured by Mizuho Kogyo, Nanomizer manufactured by NANOMIZER Inc., and APV Gaulin manufactured by SPX Corporation), a membrane emulsifier (e.g., Membrane Emulsifier manufactured by REICA Co., Ltd.), a vibration emulsifier (e.g., Vibro Mixer manufactured by [REICA Co., Ltd.], and a ultrasonic emulsifier (e.g., Sonic Homogenizer manufactured by Branson Ultrasonic Corporation).

Examples of the process of removing the organic solvent (C) from the dispersion liquid (DF) include a method for removing by decompression. In the case where (C) is removed by decompression, however, the decompression degree and temperature need to be controlled so as not to remove (E) at the same time.

In the case where (F) is (F1), (C) is condensed in (DF) as (C) is removed by decompression. As a result, a problem that particles of (X) may be cohered to each other may occur.

In the case where (F) is (F1), therefore, the preferable method is that (F1) is further mixed in (DF) to extract (C) present in (X) into a phase of (DF), (DF) is then substituted with (F1), followed by decompressing (0.1 MPa to 20 MPa).

When (F1) is further mixed in (DF), (F1) having higher pressure than that of (DF) may be added, or (DF) may be added to (F1) having lower pressure than that of (DF). However, the latter is preferable in view of easiness of a continuous operation thereof. Considering prevention of cohesion of (X), an amount of (F1) mixed with (DF) is preferably 1 time to 50 times the volume of (DF), more preferably 1 time to 40 times, and even more preferably 1 time to 30 times.

Examples of the method for substituting (DF) with (F1) include a method containing, after capturing the toner (X) with a filter or cyclone, passing (F1) until (C) is completely removed, while maintaining the pressure. An amount of the (F1) to be passed is preferably 1 time to 100 times the volume of (DF), more preferably 1 time to 50 times, and even more preferably 1 time to 30 times, in view of easiness of removal of (C).

In the case where (F) is (F2) or (F3), examples of the process of removing the organic solvent (C) from the dispersion liquid (DF) include a method in which (C) is removed by decompression (0.001 MPa to 0.05 MPa).

In the method for producing a toner (X) of the present invention, removing the dispersion medium (F) is performed after removing the organic solvent (C), to thereby separating the toner (X) from (F).

The method for removing (F) is not particularly limited, and examples thereof include a method in which (F) is removed by decompression, and a method in which a solid-liquid separation is performed by filtering and or using centrifugal separation device, and drying is performed.

The toner (X) is obtained as toner core particles (G) on each surface of which resin particles (E) are deposited, and therefore (E) needs to have an adsorption power to (G). The adsorption power of (E) to (G) can be controlled by the following methods.

(1) Designing (E) and (G) to have reverse electric charges to each other to generate an adsorption power. In this case, the adsorption power increases, as the electric charges of (E) and (G) each increase.
(2) The adsorption power increases, as a surfactant is used in the dispersion medium (F3).
(3) Designing the crystalline resin (A) and the crystalline polyurethane resin (B) to have a small difference between SP values thereof, to thereby increase the adsorption power.

In the method for producing a toner (X) of the present invention, shapes or surface configurations of particles of (X) can be controlled by controlling the SP value difference between the crystalline resin (A) and the crystalline polyurethane resin (B), or Mw of (A). When the SP value difference between (A) and (B) is small, particles of (X) having irregular shapes, and smooth surfaces tend to be obtained. When the SP value difference is large, particles of (X) having spherical shapes, and rough surfaces tend to be obtained.

When Mw of (A) is large, moreover, particles of (X) having rough surfaces tend to be obtained. When Mw of (A) is small, particles of (X) having smooth surfaces tend to be obtained. However, the excessively small or large SP value difference between (A) and (B) make granulation of (X) difficult. Moreover, the excessively small Mw of (A) makes granulation difficult.

Accordingly, the difference in the SP value between (A) and (B) is preferably 0.01 (cal/cm³)^{1/2} to 5.0 (cal/cm³)^{1/2}, more preferably 0.1 (cal/cm³)^{1/2} to 3.0 (cal/cm³)^{1/2}, and even more preferably 0.2 (cal/cm³)^{1/2} to 2.0(cal/cm³)^{1/2}.

### EXAMPLES

The present invention will be further explained through Examples hereinafter, but Examples shall not be construed as to limit the scope of the present invention.

### Production Example 1

### Production of Crystalline Polyurethane Resin (B-1) Solution

A reaction device equipped with a stirrer and a thermometer was charged with 74 parts by mass of polyester diol [hydroxyl value: 56] composed of ethylene glycol and sebacic acid, 20 parts by mass of 1,9-nonanediol, 47 parts by mass of 2,2-dimethylol propionic acid, 9 parts by mass of sodium 3-(2,3-dihydroxypropoxy)-1-propane sulfonate, 100 parts by mass of hexamethylene diisocyanate, 4 parts by mass of triethylamine, and 250 parts by mass of acetone, while introducing nitrogen therein. Thereafter, the resulting mixture was heated to 50° C., and a urethanation reaction was carried out for 10 hours, to thereby produce a solution of a urethane resin having an isocyanate group at a terminal thereof. Subsequently, to the resulting the urethane resin solution, 8 parts by mass of n-butyl amine, and 31 parts by mass of triethyl amine were added, and the resulting mixture was allowed to react for 3 hours at 50° C., to thereby obtain an acetone solution of a crystalline polyurethane resin (B-1). The NCO content of (B-1) was 0% by mass.

### Production Example 2

### Production of Crystalline Polyurethane Resin (B-2) Solution

A reaction vessel equipped with a stirrer and a thermometer was charged with 379.7 parts by mass of polyester diol (hydroxyl value: 44) composed of ethylene glycol and sebacic acid, 26.9 parts by mass of 2,2-dimethylol propionic acid, 2.4 parts by mass of N,N-bis(2-hydroxyethyl)sulfamic acid, 76 parts by mass of isophorone diisocyanate, and 500 parts by mass of acetone, while introducing nitrogen therein. Thereafter, the resulting mixture was heated to 90° C., and a urethanation reaction was carried out for 40 hours, to thereby produce an acetone solution of a crystalline urethane resin having a hydroxyl group at a terminal thereof (B-2). The NCO content of (B-2) was 0% by mass.

### Production Example 3

### Production of Crystalline Polyurethane Resin (B-3) Solution

A reaction vessel equipped with a stirrer and a thermometer was charged with 377.3 parts by mass of polyester diol (hydroxyl value: 31) composed of ethylene glycol and dodecane diacid, 30.3 parts by mass of 2,2-dimethylol propionic acid, 2.4 parts by mass of bis(2-hydroxyethyl)phosphate, 95.0 parts by mass of isophorone diisocyanate, and 487.2 parts by mass of acetone, while introducing nitrogen therein. Thereafter, the resulting mixture was heated to 90° C., and a urethanation reaction was carried out for 40 hours, to thereby obtain an acetone solution of a crystalline urethane resin having a hydroxyl group at a terminal thereof (B-3). The NCO content of (B-3) was 0% by mass.

### Production Example 4

### Production of Crystalline Polyurethane Resin (B-4) Solution

A reaction vessel equipped with a stirrer and a thermometer was charged with 447 parts by mass of polyester diol (hydroxyl value: 51) composed of ethylene glycol and dodecane diacid, 6.3 parts by mass of 2,2-dimethylol propionic acid, 2.5 parts by mass of sodium 3-(2,3-dihydroxypropoxy)-1-propane sulfonate, 44 parts by mass of hexamethylene diisocyanate, and 500 parts by mass of acetone, while introducing nitrogen therein. Thereafter, the resulting mixture was heated to 90° C., and a urethanation reaction was carried out for 40 hours, to thereby obtain an acetone solution of a crystalline urethane resin having a hydroxyl group at a terminal thereof (B-4). The NCO content of (B-4) was 0% by mass.

### Production Example 5

### Production of Prepolymer Solution for Crystalline Polyurethane Resin (B-5)

A reaction vessel equipped with a stirrer and a thermometer was charged with 99 parts by mass of polyester diol [hydroxyl value: 56] composed of ethylene glycol and sebacic acid, 50 parts by mass of polyester diol [hydroxyl value: 112] composed of ethylene glycol and sebacic acid, 50 parts by mass of 2,2-dimethylol propionic acid, 17 parts by mass of N,N-bis(2-hydroxyethyl)sulfamic acid, 67 parts by mass of diphenylmethane diisocyanate, 3 parts by mass of triethyl amine, and 250 parts by mass of acetone, while introducing nitrogen therein. Thereafter, the resulting mixture was heated to 50° C., and a urethanation reaction was carried out for 10 hours, to thereby obtain an acetone solution of a prepolymer (B0-5) of a urethane resin (B-5). The NCO content of (B0-5) was 1.7% by mass.

### Production Example 6

### Production of Crystalline Polyurethane Resin (B-6) Solution

A reaction vessel equipped with a stirrer and a thermometer was charged with 111 parts by mass of polyester diol [hydroxyl value: 112] composed of ethylene glycol and sebacic acid, 21 parts by mass of 2,2-dimethylol propionic acid, 1 part by mass of sodium 3-(2,3-dihydroxypropoxy)-1-propane sulfonate, 117 parts by mass of hexamethylene diisocyanate, 15 parts by mass of triethylamine, and 250 parts by mass of acetone, while introducing nitrogen therein. Thereafter, the resulting mixture was heated to 50° C., and a urethanation reaction was carried out for 15 hours, to thereby obtain a solution of a crystalline urethane resin having a hydroxyl group at a terminal thereof. At the time when the urethanation reaction was completed, the NCO content was 0% by mass.

### Production Example 7

### Production of Crystalline Polyurethane Resin (B-7) Solution

A reaction vessel equipped with a stirrer and a thermometer was charged with 379.7 parts by mass of polyester diol (hydroxyl value: 44) composed of ethylene glycol and sebacic acid, 26.9 parts by mass of 2,2-dimethylol propionic acid, 2.4 parts by mass of N,N-bis(2-hydroxyethyl)sulfamic acid, 76 parts by mass of isophorone diisocyanate, and 500 parts by mass of acetone, while introducing nitrogen therein. Thereafter, the resulting mixture was heated to 90° C., and a urethanation reaction was carried out for 40 hours, to thereby produce an acetone solution of a crystalline urethane resin having a hydroxyl group at a terminal thereof (B-7). The NCO content of (B-7) was 0% by mass.

### Production Example 8

### Production of Crystalline Polyurethane Resin (B-8) Solution

A reaction vessel equipped with a stirrer and a thermometer was charged with 379.7 parts by mass of polyester diol (hydroxyl value: 44) composed of ethylene glycol and sebacic acid, 26.9 parts by mass of 2,2-dimethylol propionic acid, 2.4 parts by mass of N,N-bis(2-hydroxyethyl)sulfamic acid, 76 parts by mass of isophorone diisocyanate, and 500 parts by mass of acetone, while introducing nitrogen therein. Thereafter, the resulting mixture was heated to 90° C., and a urethanation reaction was carried out for 40 hours, to thereby produce an acetone solution of a crystalline urethane resin having a hydroxyl group at a terminal thereof (B-8). The NCO content of (B-8) was 0% by mass.

### Production Example 9

### Production of Aqueous Dispersion Liquid (W-1) of Particles (E-1)

A reaction device equipped with a stirrer, a thermometer, and a desolventizing device was charged with 1,800 parts by mass of water, and the water was heated to 40° C. Next, 836 parts by mass of the acetone solution of (B-1) of Production Example 1, the temperature of which was 40° C., was added to the reaction device, with stirring, to thereby emulsify (B-1) in the water. Subsequently, the acetone was removed, to thereby obtain an aqueous dispersion liquid (W-1) of particles (E-1) formed of (B-1). The volume average particle diameter of (E-1) in (W-1) was measured by ELS-800, and was 0.05 μm.

### Production Example 10

### Production of Aqueous Dispersion Liquid (W-2) of Particles (E-2)

A reaction device equipped with a stirrer, a thermometer, and a desolventizing device was charged with 1,800 parts by mass of water, and the water was heated to 40° C. Next, 836 parts by mass of the acetone solution of (B-2) of Production Example 2, the temperature of which was 40° C., was added to the reaction device, with stirring, to thereby emulsify (B-2) in the water. Subsequently, the acetone was removed, to thereby obtain an aqueous dispersion liquid (W-2) of particles (E-2) formed of (B-2). The volume average particle diameter of (E-2) in (W-2) was measured by ELS-800, and was 0.15 μm.

### Production Example 11

### Production of Aqueous Dispersion Liquid (W-3) of Particles (E-3)

A reaction device equipped with a stirrer, a thermometer, and a desolventizing device was charged with 1,800 parts by mass of water, and the water was heated to 40° C. Next, 836 parts by mass of the acetone solution of (B-3) of Production Example 3, the temperature of which was 40° C., was added to the reaction device, with stirring, to thereby emulsify (B-3) in the water. Subsequently, the acetone was removed, to thereby obtain an aqueous dispersion liquid (W-3) of particles (E-3) formed of (B-3). The volume average particle diameter of (E-3) in (W-3) was measured by ELS-800, and was 0.30 μm.

### Production Example 12

### Production of Aqueous Dispersion Liquid (W-4) of Particles (E-4)

A reaction device equipped with a stirrer, a thermometer, and a desolventizing device was charged with 1,800 parts by mass of water, and the water was heated to 40° C. Next, 836 parts by mass of the acetone solution of (B-4) of Production Example 4, the temperature of which was 40° C., was added to the reaction device, with stirring, to thereby emulsify (B-4) in the water. Subsequently, the acetone was removed, to thereby obtain an aqueous dispersion liquid (W-4) of particles (E-4) formed of (B-4). The volume average particle diameter of (E-4) in (W-4) was measured by ELS-800, and was 0.30 μm.

### Production Example 13

### Production of Aqueous Dispersion Liquid (W-5) of Particles (E-5)

A reaction device equipped with a stirrer, a thermometer, and a desolventizing device was charged with 1,800 parts by mass of water, and the water was heated to 40° C. Next, 836 parts by mass of the acetone solution of (β0-5) of Production Example 5, the temperature of which was 40° C., was added to the reaction device, with stirring, to thereby emulsify (B0-5) in the water. To the resultant, 4.5 parts by mass of n-butyl amine, 9.5 parts by mass of hexamethylene diamine, and 10 parts by mass of triethyl amine were further added, and the resulting mixture was allowed to react for 5 hours with stirring, followed by removing the acetone, to thereby obtain an aqueous dispersion liquid (W-5) of particles (E-5) formed of a resin (B-5), which had been obtained by elongating (B0-5) with amine. The volume average particle diameter of (E-5) in (W-5) was measured by ELS-800, and was 0.05 μm.

### Production Example 14

### Production of Aqueous Dispersion Liquid (W-6) of Particles (E-6)

A reaction device equipped with a stirrer, a thermometer, and a desolventizing device was charged with 1,800 parts by mass of water, and the water was heated to 40° C. Next, 836 parts by mass of the acetone solution of (B-6) of Production Example 6, the temperature of which was 40° C., was added to the reaction device, with stirring, to thereby emulsify (B-6) in the water. Subsequently, the acetone was removed, to thereby obtain an aqueous dispersion liquid (W-6) of particles (E-6) formed of (B-6). The volume average particle diameter of (E-6) in (W-6) was measured by ELS-800, and was 0.30 μm.

### Production Example 15

### Production of Aqueous Dispersion Liquid (W-7) of Particles (E-7)

A reaction device equipped with a stirrer, a thermometer, and a desolventizing device was charged with 18 parts by mass of a 48.5% aqueous solution of sodium dodecyldiphenyl ether disulfonate (ELEMINOL MON-7, manufactured by Sanyo Chemical Industries Ltd.), and 1,800 parts by mass of water, and the resulting mixture was heated to 40° C. Next, 836 parts by mass of the acetone solution of (B-7) of Production Example 7, the temperature of which was 40° C., was added to the reaction device, with stirring, to thereby emulsify (B-7) in the water. Subsequently, the acetone was removed, to thereby obtain an aqueous dispersion liquid (W-7) of particles (E-7) formed of (B-7). The volume average particle diameter of (E-7) in (W-7) was measured by ELS-800, and was 0.20 μm.

### Production Example 16

### Production of Decane Dispersion Liquid (W-8) of Particles (E-8)

A reaction device equipped with a stirrer, a thermometer, and a desolventizing device was charged with 1,800 parts by mass of decane, and the decane was heated to 40° C. Next, 836 parts by mass of the acetone solution of (B-8) of Production Example 8, the temperature of which was 40° C., was added to the reaction device, with stirring, to thereby emulsify (B-8) in the decane. Subsequently, the acetone was removed, to thereby obtain a decane dispersion liquid (W-8) of particles (E-8) formed of (B-8). The volume average particle diameter of (E-8) in (W-8) was measured by ELS-800, and was 0.20 μm.

### Comparative Production Example 1

### Production of Comparative Polyurethane Resin (B′-1) Solution

A reaction vessel equipped with a stirrer and a thermometer was charged with 197.5 parts by mass of polyester diol (hydroxyl value: 56) composed of 1,2-propylene glycol and isophthalic acid, 10 parts by mass of 2,2-dimethylol propionic acid, 2.5 parts by mass of sodium 3-(2,3-dihydroxypropoxy)-1-propane sulfonate, 40 parts by mass of isophorone diisocyanate, 8 parts by mass of triethyl amine, and 250 parts by mass of acetone, while introducing nitrogen therein. Thereafter, the resulting mixture was heated to 50° C., and a urethanation reaction was carried out for 15 hours, to thereby obtain an acetone solution of a urethane resin having a hydroxyl group at a terminal thereof (B′-1). The NCO content of (B′-1) was 0% by mass.

### Comparative Production Example 2

### Production of Comparative Polyurethane Resin (B′-2) Solution

A reaction vessel equipped with a stirrer and a thermometer was charged with 92 parts by mass of polyethylene glycol (PEG-400, manufactured by Sanyo Chemical Industries Ltd., hydroxyl value: 278), 38 parts by mass of 2,2-dimethylol propionic acid, 3 parts by mass of sodium 3-(2,3-dihydroxypropoxy)-1-propane sulfonate, 122 parts by mass of isophorone diisocyanate, 3 parts by mass of triethylamine, and 250 parts by mass of acetone, while introducing nitrogen therein. Thereafter, the resulting mixture was heated to 50° C., and a urethanation reaction was carried out for 15 hours. Subsequently, to the resultant, 29 parts by mass of triethyl amine was added, and mixed, to thereby obtain an acetone solution of a urethane resin (B′-2). The NCO content of (B′-2) was 0% by mass.

### Comparative Production Example 3

### Production of Aqueous Dispersion Liquid (W′-1) of Particles (E′-1)

A reaction device equipped with a stirrer, a thermometer, and a desolventizing device was charged with 1,800 parts by mass of water, and the water was heated to 40° C. Next, 836 parts by mass of the acetone solution of (B′-1) of Comparative Production Example 1, the temperature of which was 40° C., was added to the reaction device, with stirring, to thereby emulsify (B′-1) in the water. Subsequently, the acetone was removed, to thereby obtain an aqueous dispersion liquid (W′-1) of particles (E′-1) formed of (B′-1). The volume average particle diameter of (E′-1) in (W′-1) was measured by ELS-800, and was 0.30 μm.

### Comparative Production Example 4

### Production of Aqueous Dispersion Liquid (W′-2) of Particles (E′-2)

A reaction device equipped with a stirrer, a thermometer, and a desolventizing device was charged with 1,800 parts by mass of water, and the water was heated to 40° C. Next, 836 parts by mass of the acetone solution of (B′-2) of Comparative Production Example 2, the temperature of which was 40° C., was added to the reaction device, with stirring, to thereby emulsify (B′-2) in the water. Subsequently, the acetone was removed, to thereby obtain an aqueous dispersion liquid (W′-2) of particles (E′-2) formed of (B′-2). The volume average particle diameter of (E′-2) in (W′-2) was measured by ELS-800, and was 0.30 μm.

Physical properties of the crystalline polyurethane resins (B-1) to (B-8) obtained in Production Examples 1 to 8, respectively, and the polyurethane resins (B′-1) and (B′-2) obtained in Comparative Production Examples 1 to 2, respectively, are presented in Table 1.

TABLE 1

| (B) | (B-1) | (B-2) | (B-3) | (B-4) | (B-5) | (B-6) | (B-7) | (B-8) |
|---|---|---|---|---|---|---|---|---|
| Tu (° C.) | 73 | 67 | 80 | 79 | 68 | 65 | 67 | 67 |
| (B-ᵤᵣₑₜₕₐₙₑ) (mass %) | 25 | 7.6 | 7.4 | 5 | 2 | 32.9 | 7.6 | 7.6 |
| (B-ᵤᵣₑₐ) (mass %) | 2.2 | 0.4 | 1.3 | 0.5 | 3 | 0 | 0.4 | 0.4 |
| (B-Mw) | 10,000 | 24,000 | 64,000 | 30,000 | 100,000 | 10,000 | 24,000 | 24,000 |
| Value of condition 2 | 19 | 6 | 19 | 5 | 27 | 25 | 6 | 6 |
| Acid value | 79 | 23 | 25 | 5 | 180 | 35 | 23 | 23 |
| (gKOH/g) | | | | | | | | |
| Presence of carboxyl | Present | Present | Present | Present | Present | Present | Present | Present |
| acid (salt) group | | | | | | | | |
| Presence of sulfonic | Present | Not | Not | Not | Not | Not | Not | Not |
| acid (salt) group | | present | present | present | present | present | present | present |
| Presence of sulfamic | Not | Present | Not | Not | Present | Not | Present | Present |
| acid (salt) | present | | present | present | | present | | |
| Presence of phosphoric | Not | Not | Present | Not | Not | Present | Not | Not |
| acid (salt) group | present | present | | present | present | | present | present |
| (E) | (E-1) | (E-2) | (E-3) | (E-4) | (E-5) | (E-6) | (E-7) | (E-8) |
| Presence of carboxylic | Present | Present | Present | Present | Present | Not | Present | Present |
| acid salt | | | | | | present | | |
| Presence of sulfonic | Present | Not | Not | Not | Not | Not | Not | Not |
| acid salt | | present | present | present | present | present | present | present |
| Presence of sulfamic | Not | Present | Not | Not | Present | Not | Present | Present |
| acid salt | present | | present | present | | present | | |
| Presence of phosphoric | Not | Not | Present | Not | Not | Present | Not | Not |
| acid salt | present | present | | present | present | | present | present |
| Volume average particle | 0.05 | 0.15 | 0.30 | 0.30 | 0.05 | 0.30 | 0.20 | 0.20 |
| diameter (μm) | | | | | | | | |
| (W) | (W-1) | (W-2) | (W-3) | (W-4) | (W-5) | (W-6) | (W-7) | (W-8) |
| Presence of active | Not | Not | Not | Not | Not | Not | Present | Not |
| agent | present | present | present | present | present | present | | present |

| (B′) | (B′-1) | (B′-2) |
|---|---|---|
| Tu (° C.) | — | 36 |
| (B-ᵤᵣₑₜₕₐₙₑ) (mass %) | 8.5 | 25.9 |
| (B-ᵤᵣₑₐ) (mass %) | 0 | 0 |
| (B-Mw) | 40,000 | 20,000 |
| Value of condition 2 | 12 | 22 |
| Acid value (gKOH/g) | 10 | 50 |
| Presence of carboxyl | Present | Present |
| acid (salt) group | | |
| Presence of sulfonic | Present | Present |
| acid (salt) group | | |
| Presence of sulfamic | Not | Not |
| acid (salt) | present | present |
| Presence of phosphoric | Not | Not |
| acid (salt) group | present | present |
| (E′) | (E′-1) | (E′-2) |
| Presence of carboxylic | Present | Present |
| acid salt | | |
| Presence of sulfonic | Present | Present |
| acid salt | | |
| Presence of sulfamic | Not | Not |
| acid salt | present | present |
| Presence of phosphoric | Not | Not |
| acid salt | present | present |
| Volume average particle | 0.30 | 0.30 |
| diameter (μm) | | |
| (W′) | (W′-1) | (W′-1) |
| Presence of active | Not | Not |
| agent | present | present |

### Production Example 17

### Synthesis of Crystalline Polyester Resin (A1-1)

A reaction device equipped with a stirrer, a thermometer, a nitrogen-inlet tube, and a decompression device was charged with 703 parts by mass of sebacic acid, 56 parts by mass of adipic acid, 379 parts by mass of 1,4-butanediol, and 0.1 parts by mass of dibutyl tin oxide, while introducing nitrogen therein. After performing the nitrogen purging of the system by decompression, the mixture was heated to 180° C., and was stirred for 6 hours at the same temperature. Thereafter, the mixture was gradually heated to 230° C. under the reduced pressure (0.007 MPa to 0.026 MPa) with still stirring, and maintained for 2 hours at the same temperature. When the mixture became viscous, the mixture was cooled down to 150° C. to terminate the reaction, to thereby synthesize a crystalline polyester resin (A1-1).

### Production Example 18

### Synthesis of Crystalline Polyester Resin (A1-2)

A crystalline polyester resin (A1-2) was obtained in the same manner as in Production Example 17, provided that 703 parts by mass of sebacic acid and 56 parts by mass of adipic acid were changed to 713 parts by mass of adipic acid, and 379 parts by mass of 1,4-butanediol was changed to 462 parts by mass of 1,4-butanediol.

### Production Example 19

### Synthesis of Crystalline Polyester Resin (A1-3)

A crystalline polyester resin (A1-3) was obtained in the same manner as in Production Example 17, provided that 703 parts by mass of sebacic acid and 56 parts by mass of adipic acid were changed to 848 parts by mass of sebacic acid, and 379 parts by mass of 1,4-butanediol was changed to a mixture of 226 parts by mass of ethylene glycol and 75 parts by mass of 1,4-butanediol.

### Production Example 20

### Synthesis of Crystalline Polyester Resin (A1-4)

A crystalline polyester resin (A1-4) was obtained in the same manner as in Production Example 17, provided that 703 parts by mass of sebacic acid and 56 parts by mass of adipic acid were changed to 627 parts by mass of isophthalic acid, and 379 parts by mass of 1,4-butanediol was changed to 508 parts by mass of 1,6-hexanediol.

### Production Example 21

### Synthesis of Crystalline Polyester Resin (A1-5)

A crystalline polyester resin (A1-5) was obtained in the same manner as in Production Example 17, provided that 703 parts by mass of sebacic acid and 56 parts by mass of adipic acid were changed to 787 parts by mass of sebacic acid, and 379 parts by mass of 1,4-butanediol was changed to 382 parts by mass of ethylene glycol.

### Production Example 22

### Production of Crystalline Polyurethane Resin (A2-1)

A reaction device equipped with a stirrer, a thermometer, a nitrogen-inlet tube, and a decompression device was charged with 216.0 parts by mass of the crystalline polyester (A1-1), 64.0 parts by mass of diphenylmethane diisocyanate, 20.0 parts by mass of 1,2-propylene glycol, and 300.0 parts by mass of tetrahydrofuran (THF), while introducing nitrogen therein. Subsequently, the resulting mixture was heated to 50° C., and a urethanation reaction was carried out for 15 hours at 50° C., to thereby obtain a THF solution of a crystalline polyurethane resin having a hydroxyl group at a terminal thereof (A2-1). Thereafter, THF was removed from the THF solution, to thereby obtain the crystalline resin (A2-1). The NCO content of (A2-1) was 0% by mass.

### Production Example 23

### Production of Crystalline Polyurethane Resin (A2-2)

A reaction device equipped with a stirrer, a thermometer, a nitrogen-inlet tube, and a decompression device was charged with 150.0 parts by mass of the crystalline polyester (A1-2), 60.0 parts by mass of hexamethylene diisocyanate, 90.0 parts by mass of cyclohexane dimethanol, and 300.0 parts by mass of THF, while introducing nitrogen therein. Subsequently, the resulting mixture was heated to 50° C., and a urethanation reaction was carried out for 15 hours at 50° C., to thereby obtain a THF solution of a crystalline polyurethane resin having a hydroxyl group at a terminal thereof (A2-2). Thereafter, THF was removed from the THF solution, to thereby obtain the crystalline resin (A2-2). The NCO content of (A2-2) was 0% by mass.

### Production Example 24

### Production of Crystalline Polyurethane Resin (A2-3)

A reaction device equipped with a stirrer, a thermometer, a nitrogen-inlet tube, and a decompression device was charged with 285.0 parts by mass of the crystalline polyester (A1-3), 15.0 parts by mass of isophorone diisocyanate, and 300.0 parts by mass of THF, while introducing nitrogen therein. Subsequently, the resulting mixture was heated to 50° C., and a urethanation reaction was carried out for 15 hours at 50° C., to thereby obtain a THF solution of a crystalline polyurethane resin having a hydroxyl group at terminal thereof (A2-3). Thereafter, THF was removed from the THF solution, to thereby obtain the crystalline resin (A2-3). The NCO content of (A2-3) was 0% by mass.

### Production Example 25

### Production of Crystalline Polyurethane Resin (A2-4)

A reaction device equipped with a stirrer, a thermometer, a nitrogen-inlet tube, and a decompression device was charged with 240.0 parts by mass of the crystalline polyester (A1-4), 33.0 parts by mass of diphenylmethane diisocyanate, 27.0 parts by mass of a bisphenol A-PO(2 mol) adduct, and 300.0 parts by mass of THF, while introducing nitrogen therein. Subsequently, the resulting mixture was heated to 50° C., and a urethanation reaction was carried out for 15 hours at 50° C., to thereby obtain a THF solution of a crystalline polyurethane resin having a hydroxyl group at terminal thereof (A2-4). Thereafter, THF was removed from the THF solution, to thereby obtain the crystalline resin (A2-4). The NCO content of (A2-4) was 0% by mass.

### Production Example 26

### Production of Crystalline Polyurethane Resin (A2-5)

A reaction device equipped with a stirrer, a thermometer, a nitrogen-inlet tube, and a decompression device was charged with 240.0 parts by mass of the crystalline polyester (A1-5), 47.0 parts by mass of xylene diisocyanate, 27.0 parts by mass of 1,2-propylene glycol, and 300.0 parts by mass of THF, while introducing nitrogen therein. Subsequently, the resulting mixture was heated to 50° C., and a urethanation reaction was carried out for 15 hours at 50° C., to thereby obtain a THF solution of a crystalline polyurethane resin having a hydroxyl group at terminal thereof (A2-5). Thereafter, THF was removed from the THF solution, to thereby obtain the crystalline resin (A2-5). The NCO content of (A2-5) was 0% by mass.

### Production Example 27

### Synthesis of Precursor (A0-1)

A reaction vessel equipped with a stirrer, a heating and cooling device, a cooling tube, and a thermometer was charged with 452 parts by mass of (A1-3), and 500 parts by mass of ethyl acetate. The resulting mixture was heated to 60° C., and stirred for 2 hours at 60° C. to thereby dissolve (A1-3). Thereafter, water was added to the resulting solution so that a moisture content in the solution became 0.06% by mass. After confirming the dissolution of (A1-3), 48 parts by mass of tolylene diisocyanate was added, and the resulting mixture was heated to 80° C., and was allowed to react for 1 hour at 80° C., to thereby obtain a solution of a precursor having an isocyanate group at a terminal thereof (A0-1). The Mw of (A0-1) was 14,000, the maximum peak temperature of heat of melting of (A0-1) was 60° C., and the isocyanate content of (A0-1) was 1.0% by mass.

### Comparative Production Example 5

### Production of Polyester Resin (A′1-1)

A reaction device equipped with a stirrer, a thermometer, a nitrogen-inlet tube, and a decompression device was charged with 67 parts by mass of a bisphenol A-PO (2 mol) adduct, 700 parts by mass of a bisphenol A-PO (3 mol) adduct, 260 parts by mass of terephthalic acid, and 1 part by mass of dibutyl tin oxide as a condensation catalyst. The resulting mixture was heated to 230° C. under atmospheric pressure, and was allowed to react for 5 hours at 230° C. The resultant was further allowed to react for 2 hours under the reduced pressure of 0.013 MPa to 0.020 MPa. Subsequently, the resultant was cooled down to 180° C., and to this, 24 parts by mass of trimellitic anhydride. The resultant was allowed to react for 2 hours under atmospheric pressure in a sealed environment, followed by cooling the resultant to room temperature, to thereby obtain a polyester resin (A′1-1).

The physical properties of the crystalline resins (A2-1) to (A2-5), and (A′1-1) obtained in Production Examples 22 to 26, and Comparative Production Example 5, respectively, are presented in Table 2.

TABLE 2

| (A), (A′) | (A2-1) | (A2-2) | (A2-3) | (A2-4) | (A2-5) | (A1′-1) |
|---|---|---|---|---|---|---|
| Ta (° C.) | 60 | 45 | 63 | 50 | 65 | — |
| Total | 60 | 40 | 80 | 40 | 120 | — |
| endothermic | | | | | | |
| value (J/g) | | | | | | |
| (a) content | 72 | 50 | 95 | 80 | 80 | 0 |
| (% by mass) | | | | | | |
| Mw | 30,000 | 50,000 | 30,000 | 18,000 | 10,000 | 7,000 |
| Presence of | Present | Present | Present | Present | Present | Present |
| ester group | | | | | | |
| Presence of | Present | Present | Present | Present | Present | Not |
| urethane | | | | | | present |
| group | | | | | | |
| Presence of | Present | Present | Present | Present | Present | Not |
| urea group | | | | | | present |

### Production Example 28

### Production of Colorant Dispersion Liquid

A reaction vessel equipped with a stirrer, a heating and cooling device, a thermometer, a cooling tube, and a nitrogen-inlet tube was charged with 557 parts by mass (17.5 parts by mole) of propylene glycol, 569 parts by mass (7.0 parts by mole) of dimethyl terephthalate, 184 parts by mass (3.0 parts by mole) of adipic acid, and 3 parts by mass of tetrabutoxy titanate as a condensation catalyst. The resulting mixture was allowed to react for 8 hours at 180° C. under a flow of a nitrogen gas, with removing the generated methanol. Subsequently, the resultant was allowed to react for 4 hours under a flow of a nitrogen gas with removing the generated propylene glycol and water, while it was gradually heated to 230° C. Then, the resultant was further allowed to react for 1 hour under the reduced pressure of 0.007 MPa to 0.026 MPa. The collected propylene glycol was 175 parts by mass (5.5 parts by mole). Subsequently, the resultant was cooled down to 180° C. To this, 121 parts by mass (1.5 parts by mole) of trimellitic anhydride, and the resulting mixture was allowed to react for 2 hours under atmospheric pressure in the sealed environment, followed by reacting until a softening point of the reaction product became 180° C. under the atmospheric pressure, to thereby obtain a polyester resin (Mn=8,500).

A beaker was charged with 20 parts by mass of copper phthalocyanine, 4 parts by mass of a colorant dispersant (SOLSPERSE 28000, manufactured by Lubrizol Corporation), 20 parts by mass of the obtained polyester resin, and 56 parts by mass of ethyl acetate, and the resulting mixture was stirred to homogeneously disperse. Thereafter, the resulting mixture was dispersed by a bead mill to finely disperse the copper phthalocyanine, to thereby obtain a colorant dispersion liquid. The volume average particle diameter of the colorant dispersion liquid as measured by LA-920 was 0.2 μm.

### Production Example 29

### Production of Modified Wax

A pressure resistant reaction vessel equipped with a stirrer, a heating and cooling device, a thermometer, and a dropping cylinder was charged with 454 parts by mass of xylene, and 150 parts by mass of low molecular polyethylene (SANWAX LEL-400, manufactured by Sanyo Chemical Industries, Ltd., softening point: 128° C.). After performing nitrogen purging, the resulting mixture was heated to 170° C. with stirring. To this, at the same temperature, a mixed solution containing 595 parts by mass of styrene, 255 parts by mass of methyl methacrylate, 34 parts by mass of di-t-butylperoxyhexahydroterephthalate, and 119 parts by mass of xylene was added dropwise over 3 hours, and the resultant was kept at the same temperature for 30 minutes.

Subsequently, xylene was removed from the resulting mixture under the reduced pressure of 0.039 MPa, to thereby obtain modified wax. The SP value of the graft chain of the modified wax was 10.35 (cal/cm³)^{1/2}, Mn thereof was 1,900, Mw thereof was 5,200, and Tg thereof was 56.9° C.

### Production Example 30

### Production of Releasing Agent Dispersion Liquid

A reaction vessel equipped with a stirrer, a heating and cooling device, a cooling tube, and a thermometer was charged with 10 parts by mass of paraffin wax (HNP-9, manufactured by NIPPON SEIRO CO., LTD., the maximum peak temperature of heat of melting: 73° C.), 1 part by mass of the modified wax obtained in Production Example 29, and 33 parts by mass of ethyl acetate. The resulting mixture was heated to 78° C. with stirring. After stirring for 30 minutes at the same temperature, the resultant was cooled down to 30° C. over 1 hour, to thereby crystallize and deposit paraffin into the shape of particles. The resultant was further subjected to wet pulverization by means of ULTRA VISCOMILL (manufactured by AIMEX CO., Ltd.), to thereby obtain a releasing agent dispersion liquid. The volume average particle diameter thereof was 0.25 μm.

### Production Example 31

### Production of Resin Solution (D-1)

A reaction vessel equipped with a stirrer and a thermometer was charged with 30 parts by mass of the colorant dispersion liquid, 140 parts by mass of the releasing agent dispersion liquid, 100 parts by mass of the crystalline resin (A2-1), and 153 parts by mass of ethyl acetate, and the resulting mixture was stirred to uniformly dissolve (A2-1), to thereby obtain a resin solution (D-1).

### Production Example 32

### Production of Resin Solution (D-2)

A reaction vessel equipped with a stirrer and a thermometer was charged with 30 parts by mass of the colorant dispersion liquid, 140 parts by mass of the releasing agent dispersion liquid, 100 parts by mass of the crystalline resin (A2-2), and 153 parts by mass of ethyl acetate, and the resulting mixture was stirred to uniformly dissolve (A2-2), to thereby obtain a resin solution (D-2).

### Production Example 33

### Production of Resin Solution (D-3)

A reaction vessel equipped with a stirrer and a thermometer was charged with 30 parts by mass of the colorant dispersion liquid, 140 parts by mass of the releasing agent dispersion liquid, 100 parts by mass of the crystalline resin (A2-3), and 153 parts by mass of ethyl acetate, and the resulting mixture was stirred to uniformly dissolve (A2-3), to thereby obtain a resin solution (D-3).

### Production Example 34

### Production of Resin Solution (D-4)

A reaction vessel equipped with a stirrer and a thermometer was charged with 30 parts by mass of the colorant dispersion liquid, 140 parts by mass of the releasing agent dispersion liquid, 100 parts by mass of the crystalline resin (A2-4), and 153 parts by mass of ethyl acetate, and the resulting mixture was stirred to uniformly dissolve (A2-4), to thereby obtain a resin solution (D-4).

### Production Example 35

### Production of Resin Solution (D-5)

A reaction vessel equipped with a stirrer and a thermometer was charged with 30 parts by mass of the colorant dispersion liquid, 140 parts by mass of the releasing agent dispersion liquid, 100 parts by mass of the crystalline resin (A2-1), and 153 parts by mass of THF, and the resulting mixture was stirred to uniformly dissolve (A2-1), to thereby obtain a resin solution (D-5).

### Production Example 36

### Production of Resin Solution (D-6)

A reaction vessel equipped with a stirrer and a thermometer was charged with 30 parts by mass of the colorant dispersion liquid, 140 parts by mass of the releasing agent dispersion liquid, 100 parts by mass of the crystalline resin (A2-1), and 153 parts by mass of methylethyl ketone, and the resulting mixture was stirred to uniformly dissolve (A2-1), to thereby obtain a resin solution (D-6).

### Production Example 37

### Production of Resin Solution (D-7)

A reaction vessel equipped with a stirrer and a thermometer was charged with 30 parts by mass of the colorant dispersion liquid, 140 parts by mass of the releasing agent dispersion liquid, 50 parts by mass of the crystalline resin (A2-1), 50 parts by mass of the crystalline resin (A2-5), and 153 parts by mass of acetone, and the resulting mixture was stirred to uniformly dissolve (A2-1) and (A2-5), to thereby obtain a resin solution (D-7).

### Production Example 38

### Production of Resin Solution (D-8)

A reaction vessel equipped with a stirrer and a thermometer was charged with 30 parts by mass of the colorant dispersion liquid, 140 parts by mass of the releasing agent dispersion liquid, 80 parts by mass of the crystalline resin (A2-1), 40 parts by mass of the precursor (A0-1), and 133 parts by mass of ethyl acetate, and the resulting mixture was stirred to uniformly dissolve (A2-1) and (A0-1), to thereby obtain a resin solution (D-8).

### Comparative Production Example 6

### Production of Resin Solution (D′-1)

A reaction vessel equipped with a stirrer and a thermometer was charged with 30 parts by mass of the colorant dispersion liquid, 140 parts by mass of the releasing agent dispersion liquid, 100 parts by mass of the polyester resin (A′1-1), and 153 parts by mass of ethyl acetate, and the resulting mixture was stirred to uniformly dissolve (A′1-1), to thereby obtain a resin solution (D′-1).

The compositions of the resin solutions (D-1) to (D-8) and (D′-1) obtained in Production Examples 31 to 38 and Comparative Production Example 6, respectively, are presented in Table 3.

TABLE 3

| Solvent | | (D-1) | (D-2) | (D-3) | (D-4) | (D-5) | (D-6) | (D-7) | (D-8) | (D′-1) |
|---|---|---|---|---|---|---|---|---|---|---|
| Colorant dispersion | | 30 | 30 | 30 | 30 | 30 | 30 | 30 | 30 | 30 |
| liquid | | | | | | | | | | |
| Releasing agent | | 140 | 140 | 140 | 140 | 140 | 140 | 140 | 140 | 140 |
| dispersion liquid | | | | | | | | | | |
| Crystalline | (A2-1) | 100 | — | — | — | 100 | 100 | 50 | 80 | — |
| resin (A) | (A2-2) | — | 100 | — | — | — | — | — | — | — |
| | (A2-3) | — | — | 100 | — | — | — | — | — | — |
| | (A2-4) | — | — | — | 100 | — | — | — | — | — |
| | (A2-5) | — | — | — | — | — | — | 50 | — | — |
| (A′1-1) | | — | — | — | — | — | — | — | — | 100 |
| Precursor | (A0-1) | — | — | — | — | — | — | — | 40 | — |
| (AO) | | | | | | | | | | |
| Organic | Ethyl | 153 | 153 | 153 | 153 | — | — | — | 133 | 153 |
| solvent (C) | acetate | | | | | | | | | |
| | Acetone | — | — | — | — | — | — | 153 | — | — |
| | Methyl | — | — | — | — | — | 153 | — | — | — |
| | ethyl | | | | | | | | | |
| | ketone | | | | | | | | | |
| | THF | — | — | — | — | 153 | — | — | — | — |

### Example 1

A beaker was charged with 170.2 parts by mass of ion-exchanged water (F3), 0.7 parts by mass of (W-3), 1 part by mass of sodium carboxymethyl cellulose, 36 parts by mass of a 48.5% aqueous solution of sodium dodecyldiphenyl ether disulfonate (ELEMINOL MON-7, manufactured by Sanyo Chemical Industries Ltd.), and 15.3 parts by mass of ethyl acetate, and the resulting mixture was stirred to uniformly dissolve. Subsequently, the resultant was heated to 50° C. To this 75 parts by mass of the resin solution (D-1) was added with stirring by means of TK Auto Homomixer at 10,000 rpm at 50° C., and the resulting mixture was stirred for 2 minutes. Subsequently, the resulting mixture was transferred into a reaction vessel equipped with a stirrer, and a thermometer, and ethyl acetate was removed from the mixture at 50° C. until the concentration thereof became 0.5% by mass or lower, to thereby obtain an aqueous resin dispersion liquid of a toner (X-1) in which shell phases (S) composed of (B) were deposited on surfaces of core phases (Q) composed of (A). Subsequently, the aqueous resin dispersion liquid was subjected to washing, filtering, and drying (at 40° C. for 18 hours) to control the volatile component thereof to 0.5% by mass or lower, to thereby obtain the toner (X-1).

### Example 2

A toner (X-2) was obtained in the same manner as in Example 1, provided that 0.7 parts by mass of (W-3) was changed to 2.1 parts by mass of (W-2).

### Example 3

A toner (X-3) was obtained in the same manner as in Example 1, provided that 75 parts by mass of the resin solution (D-1) was changed to 75 parts by mass of the resin solution (D-2), and 0.7 parts by mass of (W-3) was changed to 7.2 parts by mass of (W-2).

### Example 4

A toner (X-4) was obtained in the same manner as in Example 1, provided that 75 parts by mass of the resin solution (D-1) was changed to 75 parts by mass of the resin solution (D-3), and 0.7 parts by mass of (W-3) was changed to 34.5 parts by mass of (W-2).

### Example 5

A toner (X-5) was obtained in the same manner as in Example 1, provided that 75 parts by mass of the resin solution (D-1) was changed to 75 parts by mass of the resin solution (D-4), and 0.7 parts by mass of (W-3) was changed to 4.2 parts by mass of (W-1).

### Example 6

A toner (X-6) was obtained in the same manner as in Example 1, provided that 15.3 parts by mass of ethyl acetate was changed to 15.3 parts by mass of tetrahydrofuran, 75 parts by mass of the resin solution (D-1) was changed to 75 parts by mass of the resin solution (D-5), and 0.7 parts by mass of (W-3) was changed to 4.2 parts by mass of (W-6).

### Example 7

A toner (X-7) was obtained in the same manner as in Example 1, provided that 15.3 parts by mass of ethyl acetate was changed to 15.3 parts by mass of methylethyl ketone, 75 parts by mass of the resin solution (D-1) was changed to 75 parts by mass of the resin solution (D-6), and 0.7 parts by mass of (W-3) was changed to 4.2 parts by mass of (W-5).

### Example 8

A toner (X-8) was obtained in the same manner as in Example 1, provided that 15.3 parts by mass of ethyl acetate was changed to 15.3 parts by mass of acetone, 75 parts by mass of the resin solution (D-1) was changed to 75 parts by mass of the resin solution (D-7), and 0.7 parts by mass of (W-3) was changed to 4.2 parts by mass of (W-4).

### Example 9

A beaker was charged with 170.2 parts by mass of ion-exchanged water (F3), 2.1 parts by mass of (W-2), 1 part by mass of sodium carboxymethyl cellulose, 36 parts by mass of a 48.5% aqueous solution of sodium dodecyldiphenyl ether disulfonate (ELEMINOL MON-7, manufactured by Sanyo Chemical Industries Ltd.), and 15.3 parts by mass of ethyl acetate, and the resulting mixture was stirred to uniformly dissolve. Subsequently, the resulting mixture was heated to 50° C. To this, 75 parts by mass of the resin solution (D-8) was added with stirring by TK Auto Homomixer at 10,000 rpm at 50° C., and the resulting mixture was stirred for 2 minutes. Subsequently, the resulting mixture was transferred into a reaction vessel equipped with a stirrer and a thermometer, and ethyl acetate was removed from the mixture at 50° C. until the concentration thereof became 0.5% by mass or lower, to thereby obtain an aqueous resin dispersion liquid of a toner (X-9) in which shell phases (S) composed of (B) were deposited on surfaces of core phases (Q) composed of (A). Subsequently, the aqueous resin dispersion liquid of (X-9) was subjected to acid washing with a 0.1 mol/L aqueous hydrochloric acid solution until the pH thereof became 2.1. Thereafter, the resultant was filtered, and dried at 40° C. for 18 hours to control the volatile component thereof to 0.5% by mass or lower, to thereby obtain the toner (X-9).

### Example 10

A toner (X-10) was obtained in the same manner as in Example 1, provided that 75 parts by mass of the resin solution (D-1) was changed to 75 parts by mass of the resin solution (D-8), and 0.7 parts by mass of (W-3) was changed to 2.1 parts by mass of (W-7).

### Example 11

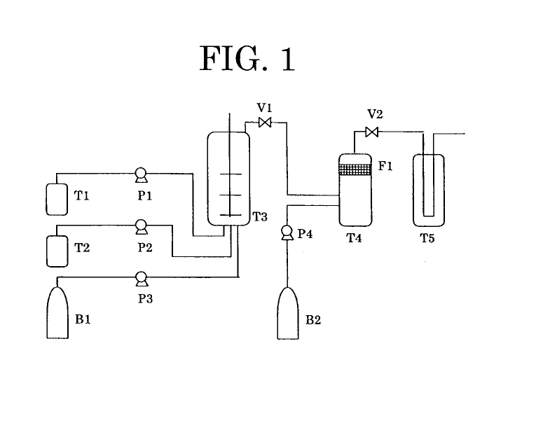

In the experimental device of FIG. 1, at first, the valves V1, V2 were closed, and carbon dioxide (purity: 99.99% by volume) was introduced into the particle collection tank T4 from the bomb B2 and the pump P4, and the internal system thereof was controlled to at 14 MPa, 40° C. Moreover, the solution tank T1 was charged with the solution (D-8), and the temperature thereof was controlled to 40° C. The particle dispersion liquid tank T2 was charged with (W-8), and the temperature thereof was controlled to 40° C. Next, carbon dioxide was introduced into the dispersion tank T3 from the bomb B1 and the pump P3, and the internal system thereof was controlled at 9 MPa, 40° C. Moreover, (W-8) was introduced into the tank T2 from the pump P2. Subsequently, the solution (D-8) was introduced into the dispersion tank T3, while stirring inside the dispersion tank T3. The internal pressure of T3 after the introduction of the solution (D-8) was 14 MPa.

The mass ratio of each component loaded in the dispersion tank was as follows:

| | | |
|---|---|---|
| (D-8) | 75 | parts by mass |
| (W-8) | 2.1 | parts by mass |
| Carbon dioxide | 125 | parts by mass |

Note that, the amount (parts by mass) of the introduced carbon dioxide was calculated by calculating the density of carbon dioxide based on the temperature (40° C.) and the pressure (15 MPa) of the carbon dioxide using the characteristic equation described in the literature (Journal of Physical and Chemical Reference Data, vol. 25, pp. 1509 to 1596), and multiplying the obtained value by the volume of the dispersion tank T3.

The mixed liquid in T3 was stirred for 1 minute, to thereby obtain a dispersion liquid (DF). Subsequently, the valve V1 was open to introduce carbon dioxide into T4 from P3, followed by introducing the dispersion liquid (DF) into T4, and during this operation, the opening degree of V2 was controlled to maintain the pressure at a constant level. This operation was carried out for 30 seconds, and then V1 was closed.

The organic solvent (C) was removed from the solution (D-8) introduced into T4 by the aforementioned operation. The organic solvent (C) content was 45% by mass. Then, T4 was heated to 57° C., and the temperature was kept at 57° C. for 10 minutes. Thereafter, T4 was cooled down to 40° C. Subsequently, the pressure of the particle collection tank T4 was maintained at 15 MPa by controlling with the pressure control valve V2, while introducing carbon dioxide the particle collection tank T4 from the pressure bomb B2, and the pump P4. As a result, the carbon dioxide containing the organic solvent (C) was discharged to the solvent trap tank T5, as well as collecting a toner (X-11) with the filter F1. The operation for introducing carbon dioxide into the particle collection tank T4 from the pressure bomb B2 and the pump P4 was terminated when a mass of carbon dioxide introduced into the particle collection tank T4 became 5 times the mass of the carbon dioxide introduced into the dispersion tank T3. At the time this operation was terminated, the operation for exchanging the carbon dioxide containing the organic solvent (C) with carbon dioxide containing no solvent, and collecting the toner (X-11) with the filter F1 was completed. Further, the pressure control valve V2 was open little by little to decompress the internal pressure of the particle collection tank T4 to the atmospheric pressure, to thereby obtain the toner (X-11).

### Comparative Example 1>

A toner (X′-1) was obtained in the same manner as in Example 1, provided that 75 parts by mass of the resin solution (D-1) was changed to 75 parts by mass of the resin solution (D′-1), and 0.3 parts by mass of (W-3) was changed to 4.2 parts by mass of (W-2).

### Comparative Example 2

A toner (X′-2) was obtained in the same manner as in Example 1, provided that 75 parts by mass of the resin solution (D-1) was changed to 75 parts by mass of the resin solution (D′-1), and 0.3 parts by mass of (W-3) was changed to 4.2 parts by mass of (W′-1).

### Comparative Example 3

A toner (X′-3) was obtained in the same manner as in Example 1, provided that 0.3 parts by mass of (W-3) was changed to 4.2 parts by mass of (W′-2).

The composition ratios (% by mass) of (Q), (Q′), (S), (S′) of each of the toners (X-1) to (X-11), and (X′-1) to (X′-3) are presented in Table 4.

Moreover, the toners (X-1) to (X-11), and (X′-1) to (X′-3) were subjected to the measurements of the volume average particle diameter and particle size distribution, and were subjected to the evaluation of the heat resistant storage stability, low temperature fixing ability, heat adhesion, adhesion strength, image glossiness, and water resistance of an image. The results are presented in Table 4.

TABLE 4

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Toner | (X-1) | (X-2) | (X-3) | (X-4) | (X-5) | (X-6) | (X-7) | (X-8) | (X-9) |
| Solution (D) | (D-1) | (D-1) | (D-2) | (D-3) | (D-4) | (D-5) | (D-6) | (D-7) | (D-8) |
| Mass ratio of core phase (Q) | 99.5 | 98.5 | 95 | 80 | 97 | 97 | 97 | 97 | 98.5 |
| Crystalline polyurethane | (B-3) | (B-2) | (B-2) | (B-2) | (B-1) | (B-6) | (B-5) | (B-4) | (B-2) |
| resin (B) | | | | | | | | | |
| Mass ratio of shell phase (S) | 0.5 | 1.5 | 5 | 20 | 3 | 3 | 3 | 3 | 1.5 |
| Tu (° C.) | 80 | 67 | 67 | 67 | 73 | 65 | 68 | 79 | 67 |
| Ta (° C.) | 60 | 60 | 45 | 63 | 50 | 60 | 60 | 62.5 | 60 |
| Tu − Ta (° C.) | 20 | 7 | 22 | 4 | 23 | 5 | 8 | 17 | 7 |
| Volume average particle | 6.0 | 5.0 | 5.9 | 4.2 | 6.0 | 5.9 | 5.5 | 5.6 | 5.4 |
| diameter (μm) | | | | | | | | | |
| Particle size distribution | 1.19 | 1.15 | 1.11 | 1.17 | 1.13 | 1.14 | 1.13 | 1.18 | 1.17 |
| Process for transforming | None | None | None | None | None | None | None | Yes | None |
| acid | | | | | | | | | |
| Heat resistant storage | I | I | I | I | I | I | I | I | I |
| stability | | | | | | | | | |
| Low temperature fixing | 110 | 100 | 95 | 100 | 90 | 110 | 105 | 115 | 110 |
| ability (° C.) | | | | | | | | | |
| Heat adhesion | I | I | I | I | I | I | I | I | I |
| Adhesion strength | A | A | B | B | B | A | A | A | A |
| Glossiness of image | A | A | A | A | A | A | A | A | A |
| Water resistance of | 1 | 1 | 1 | 1 | 1 | 1 | 1 | 1 | 1 |
| image (mm) | | | | | | | | | |

| | | | Comp. | Comp. | Comp. |
|---|---|---|---|---|---|
| | Ex. 10 | Ex. 11 | Ex. 1 | Ex. 2 | Ex. 2 |
| Toner | (X-10) | (X-11) | (X′-1) | (X′-2) | (X′-3) |
| Solution (D) | (D-8) | (D-8) | (D′-1) | (D′-1) | (D-2) |
| Mass ratio of core phase (Q) | 98.5 | 98.5 | 97 | 97 | 97 |
| Crystalline polyurethane | (B-7) | (B-8) | (B-2) | (B′-1) | (B′-2) |
| resin (B) | | | | | |
| Mass ratio of shell phase (S) | 1.5 | 1.5 | 3 | 3 | 3 |
| Tu (° C.) | 67 | 67 | 67 | — | 36 |
| Ta (° C.) | 60 | 60 | — | — | 60 |
| Tu − Ta (° C.) | 7 | 7 | — | — | −24 |
| Volume average particle | 5.7 | 6.0 | 5.5 | 6.0 | 11.0 |
| diameter (μm) | | | | | |
| Particle size distribution | 1.19 | 1.20 | 1.20 | 1.20 | 1.54 |
| Process for transforming | None | None | None | None | None |
| acid | | | | | |
| Heat resistant storage | I | I | I | II | II |
| stability | | | | | |
| Low temperature fixing | 110 | 100 | 130 | 130 | 140 |
| ability (° C.) | | | | | |
| Heat adhesion | I | I | II | II | II |
| Adhesion strength | A | A | C | B | C |
| Glossiness of image | A | A | B | C | C |
| Water resistance of | 1 | 1 | 2 | 3 | 2 |
| image (mm) | | | | | |

### [1] Volume Average Particle Diameter and Particle Size Distribution

The toners (X-1) to (X-11), (X′-1) to (X′-3) were each dispersed in water, and subjected to the measurements of the volume average particle diameter and particle size distribution by means of Coulter Counter, Multisizer III (manufactured by Beckman Coulter, Inc.).

### [2] Heat Resistant Storage Stability

The toners (X-1) to (X-11), (X′-1) to (X′-3) were each left to stand in the atmosphere of 40° C. for 1 day, and the degree of the blocking was visually judged. The heat resistant storage stability was evaluated based on the following criteria.

### [Evaluation Criteria]

I: No blocking occurred.

II: Blocking occurred.

### [3] Low Temperature Fixing Ability

To each of the toners (X-1) to (X-11), (X′-1) to (X′-3), 1.0% by mass of Aerosil R972 (manufactured by Nippon Aerosil Co., Ltd.) was added, and the resulting mixture was sufficiently mixed to make the mixture homogeneous. Thereafter, the resulting powder was placed on paper in an amount of 0.6 mg/cm² (as a method for placing the powder, a printer from which a heat fixing device was taken out was used. Any other method may be used as long as it could uniformly place the powder with the aforementioned mass density). The temperature at which cold offset occurred was measured when the paper was passed through under the conditions where the fixing speed (heat roller rim speed) of the press roller was 213 mm/sec, and the fixing pressure (pressure of the press roller) was 10 kg/cm².

The term “offset” means that the toner on paper is transferred to the side of the heat roller, and the toner is returned again on the paper from the heat roller as the heat roller is rotated once. The term “cold offset” means that, when temperature of the heat roller is low, the toner, which is not fixed (as it is not melted), is transferred from paper to the heat roller to cause the offset. The cold offset occurring temperature is temperature at which the offset occurs, and is the highest temperature of the heat roller.

The lower the cold offset occurring temperature, the low temperature fixing ability is more excellent.

### [4] Heat Adhesion

Each of the toners (X-1) to (X-11), (X′-1) to (X′-3) was electrostatically applied onto a zinc phosphate-treated steel standard plate (manufactured by Nippon Testpanel Co., Ltd.] by a commercially available corona-charge spray gun, so that a film thickness of the toner became 40 μm to 60 μm, and the film was baked for 20 minutes at 100° C. Thereafter, the resulting film was subjected to a shear adhesion test in accordance with the method specified in JIS K6830. The heat adhesion was evaluated based on the following criteria.

### [Evaluation Criteria]

I: Aggregation fracture

II: Interface fracture

### [5] Adhesion Strength

The image fixed at 160° C. was used from the evaluation samples used for the aforementioned evaluation of the low temperature fixing ability. The image was subjected to a pencil hardness test in accordance with the method specified in JIS K5600-5-4, and the adhesion strength was evaluated based on the following criteria.

### [Evaluation Criteria]

A: HB or harder

B: 4B to B

C: 5B or softer

### [6] Glossiness of Image

The image fixed at 160° C. was used from the evaluation samples used for the aforementioned evaluation of the low temperature fixing ability. The glossiness of the image was measured by means of a glossimeter manufactured by NIPPON DENSHOKU INDUSTRIES CO., LTD., with an incident angle of 60°.

### [Evaluation Criteria]

A: The glossiness was 10% or more.

B: The glossiness was 2% or more but less than 10%.

C: The glossiness was less than 2%.

### [7] Water Resistance of Image

The image fixed at 160° C. was used from the evaluation samples used for the aforementioned evaluation of the low temperature fixing ability. The image was cut into a size of 4 cm×4 cm, and the obtained cut piece was immersed in a diluted red ink fluid, which was a red ink fluid (PILOT INK RED, manufactured by PILOT CORPORATION) diluted 100 fold with water. The width of the ink penetrating into the edge of the cut piece was measured, and the maximum value (mm) was determined as a factor for water resistance. The smaller the numerical value is, the image has more excellent water resistance.

Note that, the embodiments described above are preferable examples of the present invention, but the present invention is not limited to these embodiments. Various modifications can be made as long as they are not apart from the spirit of the present invention.

The embodiments of the present invention are as follows:

<1> A toner (X) containing:

toner particles, each toner particle contains:

a core phase (Q) containing a crystalline resin (A); and

a shell phase (S) provided on a surface of the core phase (Q), where the shell phase (S) contains a crystalline polyurethane resin (B),

wherein maximum peak temperature (Ta) of heat of melting of the crystalline resin (A) is 40° C. to 70° C., and maximum peak temperature (Tu) of heat of melting of the crystalline polyurethane resin (B) is 50° C. to 90° C.

<2> The toner (X) according to <1>, wherein the toner (X) satisfies the following condition 1:

0(° C.)≦(Tu)−(Ta)≦30(° C.) Condition 1

<3> The toner (X) according to any of <1> or <2>, wherein the crystalline polyurethane resin (B) satisfies the following condition 2:

5≦0.94(B-urethane)+0.70(B-urea)+0.00032(B-Mw)−9.2 Condition 2

where (B-urethane) is a concentration (% by mass) of urethane groups in the crystalline polyurethane resin (B); (B-urea) is a concentration (% by mass) of urea groups in the crystalline polyurethane resin (B); and (B-Mw) is a weight average molecular weight (Mw) of the crystalline polyurethane resin (B).

<4> The toner (X) according to any one of <1> to <3>, wherein the crystalline polyurethane resin (B) has an acid value of 5 mgKOH/g to 200 mgKOH/g.
<5> The toner (X) according to any one of <1> to <4>, wherein the crystalline polyurethane resin (B) contains at least one selected from the group consisting a carboxylic acid group and a salts thereof, a sulfonic acid group and a salts thereof, a sulfamic acid group and a salts thereof, and a phosphoric acid group and a salts thereof.
<6> The toner (X) according to any one of <1> to <5>, wherein a mass ratio of the core phase (Q) to the shell phase (S) is 99.9:0.1 to 75:25.
<7> The toner (X) according to any one of <1> to <6>, wherein Wherein a total endothermic value of the crystalline resin (A) is 20 J/g to 150 J/g.
<8> The toner (X) according to any one of <1> to <7>, wherein the crystalline resin (A) is a block resin composed of a crystalline segment (a) and a non-crystalline segment (a′).
<9> The toner (X) according to any one of <1> to <8>, wherein the crystalline resin (A) contains an ester group, a urethane group, and a urea group.
<10> A method for producing a toner (X) containing:

dispersing a solution (D), which is prepared by dissolving a crystalline resin (A) in an organic solvent (C), in a dispersion medium (F), which is prepared by dispersing resin particles (E) each containing a crystalline polyurethane resin (B), to thereby obtain a dispersion liquid (DF); and

removing the organic solvent (C) and the dispersion medium (F) from the dispersion liquid (DF), and depositing the resin particles (E) on surfaces of toner core particles (G) each containing the crystalline resin (A), to thereby form a shell phase (S) containing the crystalline polyurethane resin (B) on a surface of a core phase (Q) containing the crystalline resin (A),

wherein maximum peak temperature (Ta) of heat of melting of the crystalline resin (A) is 40° C. to 70° C., and maximum peak temperature (Tu) of heat of melting of the crystalline polyurethane resin (B) is 50° C. to 90° C.

<11> The method according to <10>, wherein the crystalline resin (A) is formed from a precursor (A0) thereof.
<12> The method according to <11>, wherein the precursor (A0) is a combination of a prepolymer containing a reactive group (α) and a curing agent (β).
<13> The method according to any one of <10> to <12>, wherein the resin particles (E) have a volume average particle diameter of 0.01 μm to 0.5 μm.
<14> The method according to any one of <10> to <13>, wherein each of

the resin particles (E) contains at least one group selected from the group consisting of a carboxylic acid salt group, a sulfonic acid salt group, a sulfamic acid salt group, and a phosphoric acid salt group.

<15> The method according to <14>, further containing:

after the dispersing the solution (D) in the dispersion medium (F) to obtain the dispersion liquid (DF),

transforming the at least one group selected from the group consisting of a carboxylic acid salt group, a sulfonic acid salt group, a sulfamic acid salt group, and a phosphoric acid salt group, which is contained in the resin particles (E), into at least one group selected from the group consisting of a carboxylic acid group, a sulfonic acid group, a sulfamic acid group, and a phosphoric acid group.

<16> The method according to any one of <10> to <15>, wherein the dispersion medium (F) is carbon dioxide (F1) in a fluid state or a supercritical state.
<17> The method according to any one of <10> to <15>, wherein the dispersion medium (F) is an aqueous medium (F3).

This application claims priority to Japanese application No. 2012-204322, filed on Sep. 18, 2012 and incorporated herein by reference.

What is claimed is:

1. A toner (X) comprising:
toner particles, each toner particle contains:
a core phase (Q) containing a crystalline resin (A); and
a shell phase (S) provided on a surface of the core phase (Q), where the shell phase (S) contains a crystalline polyurethane resin (B),
wherein maximum peak temperature (Ta) of heat of melting of the crystalline resin (A) is 40° C. to 70° C., and maximum peak temperature (Tu) of heat of melting of the crystalline polyurethane resin (B) is 50° C. to 90° C.

2. The toner (X) according to claim 1, wherein the toner (X) satisfies the following condition 1:
0(° C.)≦(Tu)−(Ta)≦30(° C.) Condition 1

3. The toner (X) according to claim 1, wherein the crystalline polyurethane resin (B) satisfies the following condition 2:
5≦0.94(B-urethane)+0.70(B-urea)+0.00032(B-Mw)−9.2 Condition 2
where (B-urethane) is a concentration (% by mass) of urethane groups in the crystalline polyurethane resin (B); (B-urea) is a concentration (% by mass) of urea groups in the crystalline polyurethane resin (B); and (B-Mw) is a weight average molecular weight (Mw) of the crystalline polyurethane resin (B).

4. The toner (X) according to claim 1, wherein the crystalline polyurethane resin (B) has an acid value of 5 mgKOH/g to 200 mgKOH/g.

5. The toner (X) according to claim 1, wherein the crystalline polyurethane resin (B) contains at least one selected from the group consisting a carboxylic acid group and a salts thereof, a sulfonic acid group and a salts thereof, a sulfamic acid group and a salts thereof, and a phosphoric acid group and a salts thereof.

6. The toner (X) according to claim 1, wherein a mass ratio of the core phase (Q) to the shell phase (S) is 99.9:0.1 to 75:25.

7. The toner (X) according to claim 1, wherein
Wherein a total endothermic value of the crystalline resin (A) is 20 J/g to 150 J/g.

8. The toner (X) according to claim 1, wherein the crystalline resin (A) is a block resin composed of a crystalline segment (a) and a non-crystalline segment (a′).

9. The toner (X) according to claim 1, wherein the crystalline resin (A) contains an ester group, a urethane group, and a urea group.

10. A method for producing a toner (X) comprising:
dispersing a solution (D), which is prepared by dissolving a crystalline resin (A) in an organic solvent (C), in a dispersion medium (F), which is prepared by dispersing resin particles (E) each containing a crystalline polyurethane resin (B), to thereby obtain a dispersion liquid (DF); and
removing the organic solvent (C) and the dispersion medium (F) from the dispersion liquid (DF), and depositing the resin particles (E) on surfaces of toner core particles (G) each containing the crystalline resin (A), to thereby form a shell phase (S) containing the crystalline polyurethane resin (B) on a surface of a core phase (Q) containing the crystalline resin (A),
wherein maximum peak temperature (Ta) of heat of melting of the crystalline resin (A) is 40° C. to 70° C., and maximum peak temperature (Tu) of heat of melting of the crystalline polyurethane resin (B) is 50° C. to 90° C.

11. The method according to claim 10, wherein the crystalline resin (A) is formed from a precursor (A0) thereof.

12. The method according to claim 11, wherein the precursor (A0) is a combination of a prepolymer containing a reactive group (α) and a curing agent (β).

13. The method according to claim 10, wherein the resin particles (E) have a volume average particle diameter of 0.01 μm to 0.5 μm.

14. The method according to claim 10, wherein each of the resin particles (E) contains at least one group selected from the group consisting of a carboxylic acid salt group, a sulfonic acid salt group, a sulfamic acid salt group, and a phosphoric acid salt group.

15. The method according to claim 14, further comprising:
after the dispersing the solution (D) in the dispersion medium (F) to obtain the dispersion liquid (DF),
transforming the at least one group selected from the group consisting of a carboxylic acid salt group, a sulfonic acid salt group, a sulfamic acid salt group, and a phosphoric acid salt group, which is contained in the resin particles (E), into at least one group selected from the group consisting of a carboxylic acid group, a sulfonic acid group, a sulfamic acid group, and a phosphoric acid group.

16. The method according to claim 10, wherein the dispersion medium (F) is carbon dioxide (F1) in a fluid state or a supercritical state.

17. The method according to claim 10, wherein the dispersion medium (F) is an aqueous medium (F3).
